(19) United States
(12) Patent Application Publication
(10) Pub. No.: US 2026/0150136 A1
(43) Pub. Date: May 28, 2026

(54) ELECTRONIC DEVICE FOR ESTABLISHING NEIGHBOR AWARENESS NETWORKING (NAN) COMMUNICATION AND OPERATING METHOD OF ELECTRONIC DEVICE

(71) Applicant: SAMSUNG ELECTRONICS CO., LTD., Suwon-si (KR)

(72) Inventors: Junsung KIM, Suwon-si (KR); Buseop JUNG, Suwon-si (KR)

(21) Appl. No.: 19/177,955

(22) Filed: Apr. 14, 2025

Related U.S. Application Data
(63) Continuation of application No. PCT/KR2023/014840, filed on Sep. 26, 2023.

(30) Foreign Application Priority Data
Oct. 14, 2022 (KR) 10-2022-0132388
Oct. 28, 2022 (KR) 10-2022-0141187

(51) Int. Cl. H04W 76/14; H04W 4/80; H04W 56/00; H04W 84/18

(52) U.S. Cl. CPC H04W 76/14; H04W 4/80; H04W 56/001; H04W 84/18

(57) ABSTRACT

An electronic device comprises a communication circuit, a processor operatively coupled to the communication circuit, and a memory connected electrically to the processor and configured to store instructions executable by the processor, wherein the instructions, when executed by the processor, cause the electronic device to receive, from an external electronic device, a discovery message through a first communication method of short-range wireless communication, activate an interface for performing a second communication method on the basis of identifying that the discovery message includes information related to the second communication method of the short-range wireless communication, transmit, to the external electronic device through the first communication method, a response message including information for performing the short-range wireless communication through the second communication method, and connect to the external electronic device through the second communication method on the basis of the information for performing the short-range wireless communication through the second communication method.

### CROSS-REFERENCE

This application is a continuation application of International Application No. PCT/KR 2023/014840 designating the United States, filed on Sep. 26, 2023, in the Korean Intellectual Property Receiving Office and claiming priority to Korean Patent Application No. 10-2022-0132388, filed on Oct. 14, 2022, in the Korean Intellectual Property Office, and to Korean Patent Application No. 10-2022-0141187, filed on Oct. 28, 2022, in the Korean Intellectual Property Office, the disclosures of all of which are incorporated by reference herein in their entireties.

### BACKGROUND

### Technical Field

Various embodiments of the disclosure relate to an electronic device and an operating method of the electronic device, and relate to an electronic device for configuring neighbor awareness networking (NAN) communication.

### Background Art

With the spread of various electronic devices, the speed of wireless communication that may be used by various electronic devices has been improved.

In addition, various types of proximity services utilizing low-power discovery technology have been developed recently. For example, proximity services (or proximity communication services) have been developed to enable nearby electronic devices to rapidly exchange data via a proximity network. The proximity services may include a low-power proximity services using a Bluetooth low energy (BLE) beacon or low-power proximity services based on short-range communication technologies (e.g., neighbor awareness networking (NAN) and Wi-Fi aware) (hereinafter referred to as “NAN”) based on wireless local area networks (WLAN).

According to an embodiment, a NAN-based low-power proximity service (hereinafter referred to as “proximity service”) refers to a service that configures and utilizes a proximity network that is dynamically changing according to the movement of electronic devices, and a set of electronic devices configuring a proximity network may be referred to as a cluster. In the case of the proximity service, signals for discovery (e.g., a beacon) and service discovery frames (SDF) (hereinafter referred to as “SDF”) may be transmitted and/or received within a time duration (or communication duration) during which electronic devices included in a cluster are synchronized with each other. For example, at least one electronic device in a cluster may transmit a signal for notifying the existence of the cluster, and a new electronic device attempting to join the cluster may receive the signal.

Electronic devices within a cluster may configure different active durations during which signals are transmittable and/or receivable, to reduce current consumption (or power consumption). In NAN communication, an active duration during which signals are transmittable and/or receivable may be referred to as a discovery window (DW). In addition, electronic devices included within a cluster may reduce current consumption by maintaining a low-power state (e.g., sleep state) within a duration other than a discovery window. Furthermore, research is being conducted on methods for reducing current consumption in NAN.

### SUMMARY

An electronic device according to an embodiment may include a communication circuit. The electronic device may include a processor operatively connected to the communication circuit. The processor may receive a discovery message via a first communication method of short-range wireless communication from an external electronic device. The processor may activate an interface for performing a second communication method, based on identifying that information related to the second communication method of the short-range wireless communication is included in the discovery message. The processor may transmit a response message including the information for performing the short-range wireless communication using the second communication method to the external electronic device via the first communication method. The processor may be configured to establish a connection with the external electronic device via the second communication method, based on the information for performing the short-range wireless communication using the second communication method.

An operating method of an electronic device according to an embodiment may include receiving a discovery message via a first communication method of short-range wireless communication from an external electronic device. The operating method of the electronic device may include activating an interface for performing a second communication method of the short-range wireless communication, based on identifying that information related to the second communication method of the short-range wireless communication is included in the discovery message. The operating method of the electronic device may include transmitting a response message including the information for performing the short-range wireless communication using the second communication method to the external electronic device via the first communication method. The operating method of the electronic device may include establishing a connection with the external electronic device via the second communication method, based on the information for performing the short-range wireless communication using the second communication method.

An electronic device according to an embodiment may include a communication circuit. The electronic device may include a processor operatively connected to the communication circuit. The processor may transmit a discovery message including information related to a second communication method of the short-range wireless communication to an external electronic device via a first communication method of the short-range wireless communication. The processor may receive a response message including information for performing the short-range wireless communication via the second communication method from the external electronic device via the first communication method. The processor may be configured to establish a connection with the external electronic device via the second communication method, based on the information for performing the short-range wireless communication via the second communication method.

### BRIEF DESCRIPTION OF THE DRAWINGS

FIG. 1 is a block diagram of an electronic device according to an embodiment.

FIG. 2 ILLUSTRATES A NEIGHBOR AWARENESS NETWORK (NAN) CLUSTER ACCORDING TO an embodiment.

FIG. 3 illustrates a protocol for transmitting a signal of an electronic device included in a NAN cluster according to an embodiment.

FIG. 4 illustrates an example of data transmission and/or reception within a NAN cluster according to an embodiment.

FIG. 5A illustrates a first electronic device and a second electronic device according to an embodiment.

FIG. 5B illustrates an embodiment in which a second electronic device is synchronized to a cluster including a first electronic device, according to an embodiment.

FIG. 6 illustrates a first electronic device according to various embodiments of the disclosure.

FIG. 7 illustrates a second electronic device according to various embodiments of the disclosure.

FIG. 8 illustrates an embodiment in which a first electronic device and a second electronic device are connected via a second communication method before being connected via a first communication method, according to an embodiment.

FIG. 9 illustrates an embodiment in which a first electronic device and a second electronic device are connected via a second communication method while being connected via a first communication method, according to an embodiment.

FIG. 10 is an operation flowchart illustrating an operation method of an electronic device according to an embodiment.

FIG. 11 is an operation flowchart illustrating an operation method of an electronic device according to an embodiment.

FIG. 12 is an operation flowchart illustrating an operation method of an electronic device according to an embodiment.

### DETAILED DESCRIPTION

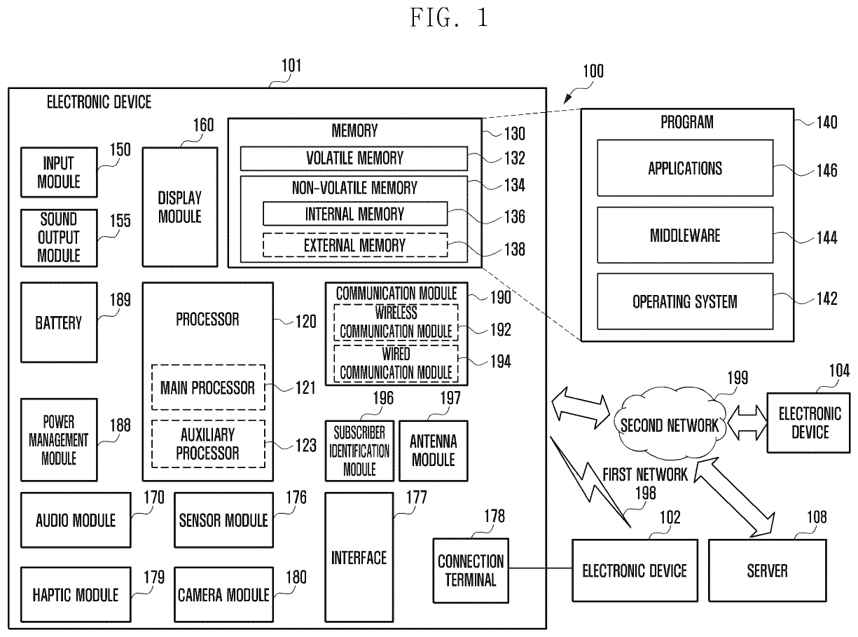

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

An electronic device may transmit or receive data within a discovery window. The discovery window may be a duration during which electronic devices included in a NAN cluster are activated, and the electronic device may perform data transmission and/or reception within the discovery window. The electronic devices included in the NAN cluster may perform synchronization to transmit and/or receive data within a discovery window which substantially refers to the same time point. Furthermore, the electronic devices included in the NAN cluster may perform a series of operations for exchanging service discovery frames and/or configuring a NAN data path (NDP), which is a path for transmitting data, thereby transmitting or receiving data.

The latency incurred in receiving information for performing synchronization, the latency incurred in performing synchronization, and the latency required for exchanging service discovery frames and/or establishing NDP may deteriorate the quality of the service performed by the electronic device.

The technical problems to be achieved in this document are not limited to the technical problems mentioned above, and other technical problems not mentioned will be clearly understood by those skilled in the art to which the disclosure belongs from the description below.

An electronic device and an operating method of the electronic device according to an embodiment may allow information for performing a second communication method to be included in a signal exchanged during a connection via a first communication method. The information for performing the second communication method may include information for synchronization with a cluster of the second communication method. Accordingly, the electronic device can receive information for synchronization with a cluster of the second communication method before activation of the second communication method, thereby performing rapid synchronization of the second communication method.

An electronic device and an operating method of the electronic device according to an embodiment may allow information for performing a second communication method to be included in a signal exchanged during a connection via a first communication method. The information for performing the second communication method may include configuration information of a data path of the second communication method. Accordingly, the electronic device can receive, before activation of the second communication method, configuration information of a data path of the second communication method, which could have received within a discovery window after activation of the second communication method, thereby reducing the latency of data transmission and/or reception via the second communication method.

The effects obtainable from the disclosure are not limited to the effects mentioned above, and other effects not mentioned will be clearly understood by those skilled in the art to which the disclosure pertains from the description below.

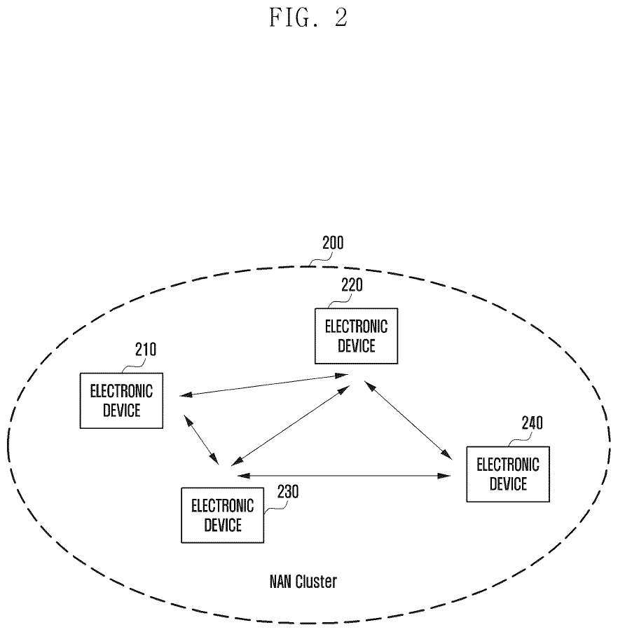

FIG. 2 illustrates a neighbor awareness network (NAN) cluster according to various embodiments.

For example, FIG. 2 may illustrate an example configuration of a neighbor awareness networking (NAN) cluster 200 for a proximity network according to various embodiments. In the following description, the cluster 200 may refer to a set of electronic devices (or NAN devices) 210, 220, 230, or 240 (e.g., the electronic device 101 of FIG. 1) that configure a proximity network so that the electronic device 210, 220, 230, or 240 may transmit and/or receive data from each other. For example, the cluster 200 may be referred to as a NAN cluster according to a NAN specification (or standard).

Referring to FIG. 2, the cluster 200 may include a plurality of electronic devices 210, 220, 230, or 240. The electronic devices 210, 220, 230, or 240 included in the cluster 200 may transmit and/or receive a beacon (or discovery beacon) and/or a service discovery frame (SDF) (hereinafter, referred to as “SDF”) within a synchronized time duration (or communication duration) (e.g., a discovery window (DW)).

The electronic devices 210, 220, 230, or 240 included in the cluster 200 may have time clocks synchronized with each other. For example, the electronic devices 210, 220, 230, 240 may be synchronized to the time clock of one electronic device (e.g., the electronic device 210) and may exchange beacons and SDFs with each other in the same discovery window.

According to an embodiment, an electronic device supporting a NAN-based low-power short-range communication technology may broadcast a search signal (e.g., a beacon) for discovering other electronic devices every preconfigured first duration (e.g., about 100 msec) and perform scanning every preconfigured second duration (e.g., about 10 msec) to receive the search signal broadcasted from the other electronic devices.

The electronic devices 210, 220, 230, 240 may detect at least one other electronic device located around the electronic devices, based on a search signal received via scanning, and perform NAN cluster synchronization with the detected at least one other electronic device. The NAN cluster synchronization may include receiving time clock information of an electronic device representing a NAN cluster so that the electronic devices included in the NAN cluster transmit and/or receive data via the same channel and/or during the same time.

For example, as illustrated in FIG. 2, each of the plurality of electronic devices 210, 220, 230, or 240 may configure a cluster 200 that operates according to a synchronized time clock, by transmitting a beacon and receiving a beacon from other electronic devices 210, 220, 230, or 240, and the electronic devices 210, 220, 230, or 240 within the cluster 200 may perform NAN cluster synchronization.

The NAN cluster synchronization may be performed based on the time and channel of an electronic device having the highest master preference within the cluster 200. For example, the electronic devices 210, 220, 230, or 240 within the cluster 200 configured via discovery may exchange signals related to master preference information indicating a preference for operating as an anchor master, and via the exchanged signals, an electronic device having the highest master preference may be determined as the anchor master (or a master electronic device).

The anchor master may refer to an electronic device which serves as a reference for time and channel synchronization of the electronic devices 210, 220, 230, or 240 within the cluster 200. The anchor master may be changed according to the master preference of the electronic device. Each of the time and channel synchronized electronic devices 210, 220, 230, or 240 may transmit a beacon and an SDF, and receive beacons and SDFs from other electronic devices within the cluster 200, within a discovery window (or a search duration) that is repeated according to a preconfigured cycle. According to an embodiment, the beacon may be transmitted and/or received periodically for each discovery window to continuously maintain time and channel synchronization of the electronic devices 210, 220, 230, or 240 within the cluster 200. The SDF may be transmitted and/or received in discovery windows as needed to provide services to the discovered electronic devices 210, 220, 230, or 240. In an embodiment, an electronic device acting as an anchor master among the time and channel synchronized electronic devices 210, 220, 230, or 240 may transmit a beacon during the interval between discovery windows to detect a new electronic device.

Each of the electronic devices 210, 220, 230, or 240 within the cluster 200 may operate in an active state only during a discovery window and operate in a low-power state (e.g., a sleep state) within the remaining duration outside the discovery window, thereby reducing current consumption.

For example, the discovery window is a duration (e.g., milliseconds) in which the electronic device stays in an active state (or awake state), resulting in high current consumption, whereas during the remaining duration outside the discovery window, the electronic device may remain in a sleep state, thereby enabling low-power discovery.

The electronic devices 210, 220, 230, or 240 within the cluster 200 may be simultaneously activated at the starting time point of a synchronized discovery window (e.g., DW start) and simultaneously transition to a sleep state at the ending time of the discovery window (e.g., DW end).

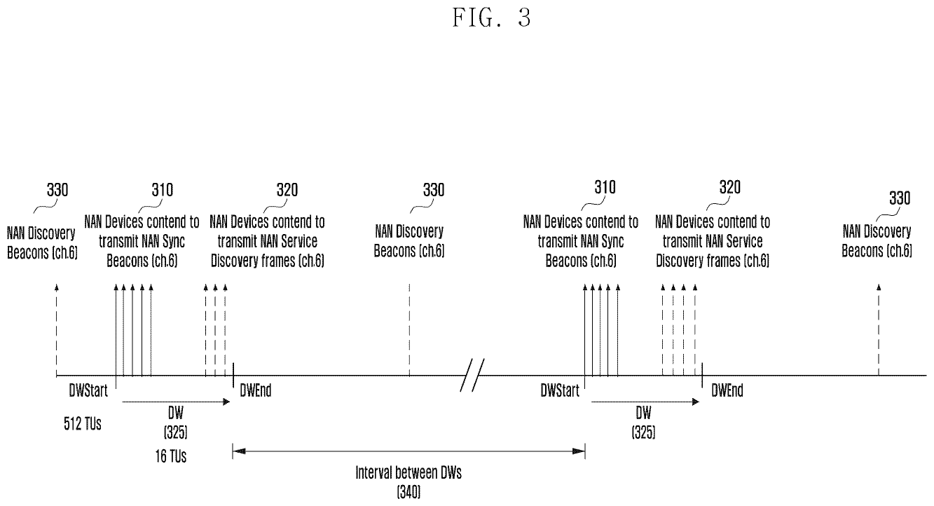

The electronic devices 210, 220, 230, or 240 included in the cluster 200 may perform discovery, synchronization, and data exchange operations using a protocol illustrated in FIG. 3 described below.

FIG. 3 illustrates a protocol for transmitting a signal of an electronic device included in a NAN cluster according to various embodiments of the disclosure.

For example, FIG. 3 may illustrate an example for a discovery window according to various embodiments. FIG. 3 shows an example in that electronic devices included in one cluster transmit signals via a specific channel (e.g., channel 6 (Ch6)), based on the NAN standard.

Referring to FIG. 3, electronic devices included in one cluster may transmit a synchronization beacon 310 and an SDF 320 within a synchronized discovery window (DW) 325. A discovery beacon 330 may be transmitted by at least one electronic device in another duration 340 (e.g., an interval between discovery windows) other than the discovery window 325. According to an embodiment, the electronic devices may transmit the synchronization beacon 310 and the SDF 320, based on contention. For example, the synchronization beacon 310 and the SDF 320 may be transmitted based on contention between the electronic devices belonging to the cluster.

The discovery window 325 may be the duration during which the electronic devices are activated to a wake-up state from a sleep state which is a power-saving mode to enable data exchange between electronic devices. For example, the discovery window 325 may be divided into time units (TUs) measured in milliseconds. According to an embodiment, the discovery window 325 for transmitting and/or receiving the synchronization beacon 310 and the SDF 320 may occupy 16 time units (16 TUs) and have a cycle (or interval) that repeats every 512 time units (512 TUs).

The discovery beacon 330 may represent a signal transmitted to enable other electronic devices that have not joined the cluster to discover the cluster. For example, the discovery beacon 330 is a signal for notifying the existence of the cluster, and electronic devices that have not joined the cluster may perform a passive scan to receive the discovery beacon 330, thereby discovering and joining the cluster.

The discovery beacon 330 may include information necessary for synchronizing with the cluster. For example, the discovery beacon 330 may include at least one of a frame control (FC) field indicating a function of a signal (e.g., a beacon), a broadcast address, a media access control (MAC) address of a transmitting electronic device, a cluster identifier (ID), a sequence control field, a time stamp for a beacon frame, a beacon interval indicating a transmission interval of the discovery beacon 330, or capability information on an electronic device transmitting the discovery beacon 330.

The discovery beacon 330 may include at least one proximity network (or cluster)-related information element. In an embodiment, the proximity network-related information may be referred to as attribute information.

The synchronization beacon 310 may indicate a signal for maintaining synchronization between the electronic devices synchronized within a cluster. The synchronization beacon 310 may be transmitted by a synchronization device among the electronic devices within the cluster. For example, the synchronization device may include an anchor master electronic device, a master electronic device, or a non-master sync device, defined in the NAN standard.

The synchronization beacon 310 may include information necessary for electronic devices to synchronize within the cluster. For example, the synchronization beacon 310 may include at least one of an FC field indicating a function of a signal (e.g., a beacon), a broadcast address, a MAC address of a transmitting electronic device, a cluster identifier, a sequence control field, a time stamp for a beacon frame, a beacon interval indicating an interval between starting time points of the discovery window 325, or capability information for a transmitting electronic device. According to an embodiment, the synchronization beacon 310 may include at least one proximity network (or cluster)-related information element. For example, the proximity network-related information may include contents for a service provided via the proximity network.

The SDF 320 may represent a signal for exchanging data via the proximity network. According to an embodiment, the SDF 320 may represent a vendor specific public action frame and include various fields. For example, the SDF 320 may include a category or action field and include at least one proximity network-related information.

The synchronization beacon 310, the SDF 320, and the discovery beacon 330 may include proximity network-related information. In an embodiment, the proximity network-related information may include an identifier indicating the type of information, the length of the information, and a body field which is corresponding information. According to an embodiment, the corresponding information may include at least one of master indication information, cluster information, service identifier list information, service descriptor information, connection capability information, wireless LAN infrastructure information, peer to peer (P2P) operation information, independent basic service set (IBSS) information, mesh information, further proximity network service discovery information, further availability map information, country code information, ranging information, cluster discovery information, or vendor specific information.

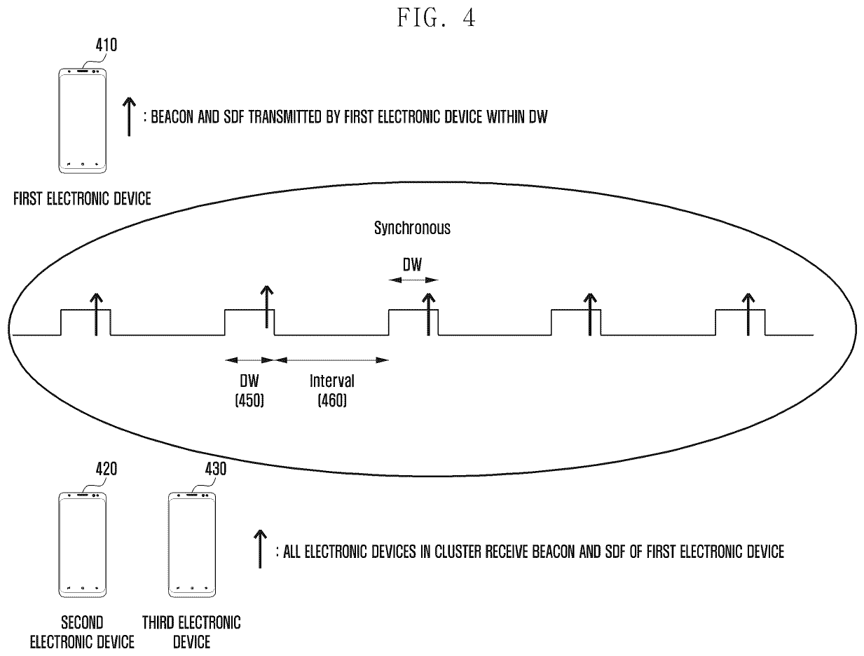

FIG. 4 illustrates an example of data transmission and/or reception within a NAN cluster according to various embodiments of the disclosure.

For example, FIG. 4 illustrates an example in which a first electronic device 410, a second electronic device 420, and a third electronic device 430 configure a cluster via wireless short-range communication technology, and the electronic devices 410, 420, or 430 may transmit and/or receive a beacon and/or an SDF to each other. According to an embodiment, FIG. 4 illustrates an example in which the first electronic device 410 among the electronic devices 410, 420, or 430 configuring the cluster acts as a master electronic device.

Referring to FIG. 4, the first electronic device 410 may transmit a beacon and an SDF within a discovery window 450. The first electronic device 410 may broadcast beacons and SDFs in each discovery window 450 which repeats over preconfigured durations (e.g., interval 460).

The second electronic device 420 and the third electronic device 430 may receive the beacon and SDF transmitted by the first electronic device 410. According to an embodiment, each of the second electronic device 420 and the third electronic device 430 may receive the beacon and SDF broadcasted in each discovery window 450 from the first electronic device 410.

The beacon transmitted within the discovery window 450 may include a synchronization beacon and include information for maintaining synchronization between the electronic devices 410, 420, or 430. For example, the second electronic device 420 and/or the third electronic device 430 may perform NAN cluster synchronization, based on the time clock information of the first electronic device 410 included in the beacon transmitted by the first electronic device 410 operating as a master. The second electronic device 420 and/or the third electronic device 430 may be synchronized and the discovery window 450 may be activated at the same time.

In a duration other than the discovery window 450 (e.g., interval 460), the electronic devices 410, 420, or 430 may maintain a sleep state to reduce current consumption. For example, the electronic devices 410, 420, or 430 may reduce current consumption by operating in a wake state only during the discovery window 450, based on a synchronized time clock.

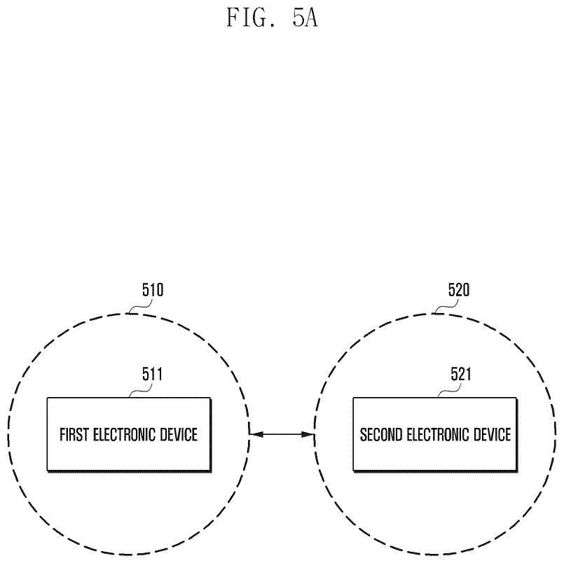

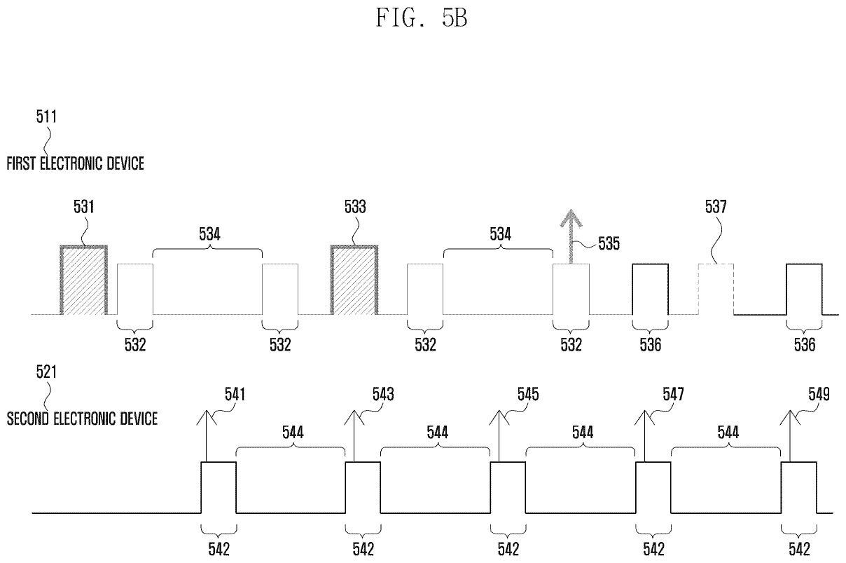

FIG. 5A illustrates a first electronic device and a second electronic device according to an embodiment.

A first electronic device 511 (e.g., the electronic device 101 of FIG. 1) may be connected to a second electronic device 521 (e.g., the electronic device 101 of FIG. 1) via various short-range wireless communications. The first electronic device 511 may transmit data (e.g., contents) to the second electronic device 521, receive data from the second electronic device 521, and perform a service based on the data.

The first electronic device 511 may be connected to the second electronic device 521 via a first communication method of short-range wireless communications. The first communication method may include device to device communication (D2D) among short-range wireless communications. According to an example, the first communication method may include Wi-Fi direct, Bluetooth, or Bluetooth low energy (BLE).

Alternatively, the first electronic device 511 may be also connected to the second electronic device 521 via a second communication method of short-range wireless communication. The second communication method may include cluster-based communication among short-range wireless communication. The cluster-based communication may refer to communication in which electronic devices included in a cluster are synchronized with each other and the electronic devices included in the cluster exchange data during the same time (e.g., discovery window). According to an example, the second communication method may include neighbor awareness network (NAN) among short-range wireless communication.

According to an example, the first electronic device 511 may be connected to the second electronic device 521 via the second communication method of short-range wireless communication when the second electronic device 521 supports the second communication method. The first electronic device 511 may be connected to the second electronic device 521 via the first communication method of short-range wireless communication when the second electronic device 521 does not support the second communication method.

The first electronic device 511 may activate an interface using the second communication method as part of an operation of activating the second communication method. The interface using the second communication method may include a hardware interface (e.g., the wireless communication module 192 of FIG. 1) and/or a software interface (e.g., an interface for processing data via the second communication method).

The first electronic device 511 may activate an interface using the second communication method and generate a first cluster 510. After generating the first cluster 510, the first electronic device 511 may receive a signal (e.g., a sync beacon signal, which is a signal for synchronizing the cluster, or a discovery signal, which is a signal for searching the cluster) transmitted (or broadcasted) by the second electronic device 521 within a duration (e.g., a discovery window) in which data transmission and/or reception is enabled over predetermined durations.

The second electronic device 521 can activate an interface using the second communication method and generate a second cluster 520. After generating the second cluster 520, the second electronic device 521 may receive a signal (e.g., a sync beacon signal, which is a signal for synchronizing the cluster, or a discovery signal, which is a signal for searching the cluster) transmitted (or broadcasted) by the first electronic device 511 within a duration (e.g., a discovery window) in which data transmission and/or reception is enabled over predetermined durations.

The starting time point of the discovery window of the first cluster 510 generated by the first electronic device 511 may be determined according to various methods. According to an example, the starting time point of the discovery window of the first cluster 510 may be configured to an arbitrary point in time. The starting time point of the discovery window of the second cluster 520 generated by the second electronic device 521 may be determined according to various methods. According to an example, the starting time point of the discovery window of the second cluster 520 may be configured to an arbitrary point in time. The starting time point of the discovery window of the first cluster 510 may be different from the starting time point of the discovery window of the second cluster 520, and the first electronic device 511 and/or the second electronic device 521 may substantially match the starting time points of the discovery windows for data communication with each other. Substantially matching the starting time points of the discovery windows may include merging the first cluster 510 and the second cluster 520 into one cluster, joining the first electronic device 511 included in the first cluster 510 to the second cluster 520, and/or joining the second electronic device 521 included in the second cluster 520 to the first cluster 510. An example of substantially matching the starting time points of the discovery windows is described below in FIG. 5B.

FIG. 5B illustrates an embodiment in which a second electronic device is synchronized to a cluster including a first electronic device, according to an embodiment.

Referring to FIG. 5B, the first electronic device (e.g., the first electronic device 511 of FIG. 5A) may operate according to the synchronized time clock of the first cluster (e.g., the first cluster 510 of FIG. 5A). For example, during a discovery window 532 (e.g., the discovery window 450 of FIG. 4) duration, the first electronic device 511 may receive a signal transmitted by an external electronic device or transmit a signal to the external electronic device.

The first electronic device 511 may not transmit and/or receive a signal by operating in a low-power state (e.g., a sleep state) within a duration 534 other than the discovery window 532.

The first electronic device 511 may perform scanning during a scanning duration 531, 533, which is different from the discovery window 532, in order to discover the second cluster (e.g., the second cluster 520 of FIG. 5A), which is a cluster other than the first cluster 510.

The length of the scanning duration 531, 533 may be configured according to various methods. The length of the scanning duration 531, 533 may be configured in consideration of the period of a signal broadcasted by an electronic device (e.g., the second electronic device 521) included in the second cluster 520. The first electronic device 511 may configure the length of the scanning duration 531, 533 such that the first electronic device 511 receives the signal broadcasted by the second electronic device 521. According to an example, the length of the scanning duration 531, 533 may be equal to the period of the signal broadcasted by the second electronic device 521 or may be greater than the period of the broadcast signal by a designated size (e.g., 10 ms). The first electronic device 511 may receive a signal broadcasted by an electronic device (e.g., the second electronic device 521) included in the second cluster 520 while performing a scan.

Referring to FIG. 5B, the second electronic device 521 may operate according to the synchronized time clock of the second cluster 520. For example, the second electronic device 521 may receive a signal transmitted by an external electronic device or transmit a signal to the external electronic device during the discovery window 542. The signals 541, 543, 545, 547, 549 transmitted by the second electronic device 521 during the discovery window 542 may include information of the second cluster 520 (e.g., characteristic information of the second cluster). The second electronic device 521 may not transmit and/or receive signals by operating in a low-power state (e.g., sleep state) within a duration 544 other than the discovery window 542.

The first electronic device 511 may not receive signals 541, 543, 545, 547, 549 transmitted by the second electronic device 521 within the scanning duration 531. The first electronic device 511 may receive a signal 543 transmitted by the second electronic device 521 and discover the second cluster 520, within the subsequent scanning duration 533.

The first electronic device 511 may determine whether to merge the first cluster 510 and the second cluster 520. The first electronic device 511 may determine whether to merge the first cluster 510 and the second cluster 520, based on the characteristics of the second cluster 520 included in the information included in the signal transmitted by the second electronic device 521. For example, the first electronic device 511 may compare the cluster grade of the first cluster 510 with the cluster grade of the second cluster 520 included in the characteristics of the second cluster 520 and determine to merge the first cluster 510 and the second cluster 520 upon identifying that the cluster grade of the second cluster 520 is greater than the cluster grade of the first cluster 510.

The first electronic device 511 may transmit a signal (e.g., a beacon signal or a synchronization signal) 535 containing information (e.g., attribute information of the second cluster 520) on a cluster (e.g., the second cluster) other than the cluster (e.g., the first cluster 510) to which the first electronic device 511 currently belongs, to other electronic devices included in the first cluster 510 a designated number of times (e.g., once) within the discovery window 532 duration of the first cluster 510, based on the determination to merge the first cluster 510 and the second cluster 520. The designated number of times may be configured according to various methods. In FIG. 5B, the signal is illustrated to be broadcast once within one discovery window 532 duration, but there is no limitation on the number of times the signal is transmitted.

The first electronic device 511 may perform a series of operations to synchronize with the second cluster 520 after transmitting a signal 535 including information of the second cluster 520. After being synchronized with the second cluster 520, the first electronic device 511 may operate according to the synchronized time clock of the second cluster 520. The first electronic device 511 may receive a signal transmitted by an external electronic device or transmit a signal to the external electronic device within the discovery window 536 (e.g., the discovery window 450 of FIG. 4). The starting time point, duration, and/or interval of the discovery window 536 may be the same as the starting time point, duration, and/or interval of the discovery window 542 of the second cluster 520.

According to an example, the first electronic device 511 may remain inactive during the discovery window 537 of the first cluster 510 after being synchronized to the second cluster 520.

The first electronic device 511 may perform configuration for performing a data communication service with the second electronic device 521 during the discovery window 536. The first electronic device 511 may exchange a service discovery frame (SDF) with the second electronic device 521 during the discovery window 536. The service discovery frame may include information indicating a service that the first electronic device 511 and/or the second electronic device 521 intend to perform. The first electronic device 511 and/or the second electronic device 521 may perform a series of operations of configuring a NAN data path (NDP), which is a path for exchanging data, during or after exchanging the service discovery frames. The first electronic device 511 and/or the second electronic device 521 may transmit or receive data via the NDP during the discovery window 536 after the configuration of the NDP is completed.

Referring to FIG. 5B, the first electronic device 511 may require a considerable amount of time to discover the second cluster 520. For example, when the first electronic device 511 fails to discover the second cluster 520 within the scanning duration 531, 533, the merging of the first cluster 510 and the second cluster 520 may not be performed, which may result in an increase in latency for services within the cluster and/or a deterioration in the quality of services.

In addition, even when the first electronic device 511 discovers the second cluster 520 and joins the second cluster 520, an increase in latency for services within the cluster and/or a deterioration in the quality of services may occur due to the operation of exchanging service discovery frames and/or the operation of configuring NDP.

Hereinafter, provided is an embodiment in which the first electronic device 511 and/or the second electronic device 521 may be quickly connected via the second communication method.

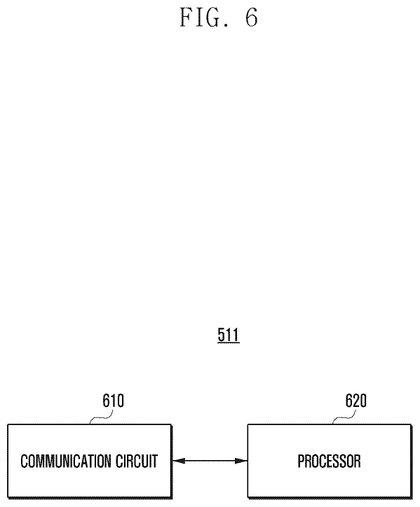

FIG. 6 illustrates a first electronic device according to various embodiments of the disclosure.

The first electronic device 511 (e.g., the first electronic device 511 of FIG. 5A) may include a communication circuit 610 (e.g., the wireless communication module 192 of FIG. 1) and a processor 620 (e.g., the processor 120 of FIG. 1).

The communication circuit 610 may include various circuit structures used for modulating and/or demodulating signals within the first electronic device 600. For example, the communication circuit 610 may modulate a baseband signal into a radio frequency (RF) signal to be output through an antenna (not shown) or may demodulate an RF signal received through an antenna into a baseband signal and transmit the same to the processor 620.

The communication circuit 610 may transmit or receive various data to or from an external electronic device via a frequency band (e.g., 2.4 GHz, 5 GHz, and/or 6 GHz) supported by short-range wireless communication. According to an example, the short-range wireless communication may include Wi-Fi defined in IEEE 802.11 WLAN.

The communication circuit 610 may support a first communication method of short-range wireless communication. The first communication method may include device-to-device communication (D2D) among short-range wireless communication. According to an example, the first communication method may include Wi-Fi direct, Bluetooth, or Bluetooth low energy (BLE).

The communication circuit 610 may support a second communication method of short-range wireless communication. The second communication method may refer to cluster-based communication among short-range wireless communication. The cluster-based communication may refer to communication in which electronic devices included in a cluster are synchronized and the electronic devices included in the cluster exchange data during the same time (e.g., discovery window). According to an example, the second communication method may include neighbor awareness network (NAN) among short-range wireless communication.

The communication circuit 610 may be connected to various external electronic devices via the first communication method and/or the second communication method, based on the control of the processor 620. Alternatively, the communication circuit 610 may be simultaneously connected to another external electronic device via the second communication method while being connected to the external electronic device via the first communication method.

The processor 620 may perform an operation of receiving data transmitted by an application processor (e.g., the processor 120 of FIG. 1) and generating a packet for transmitting the received data to the external electronic device. According to an embodiment, the processor 620 may be defined as a communication processor (or a communication processor) included in a communication module (e.g., the wireless communication module 192 of FIG. 1). According to an embodiment, the processor 620 may perform channel coding based on data transmitted by an application processor (e.g., the application processor 120 of FIG. 1), thereby generating a packet, identifying whether at least a part of data transmitted by an external electronic device (e.g., the second electronic device 521 of FIG. 5A) has an error, or performing an operation of recovering the error (e.g., hybrid auto repeat request (HARQ)) when an error occurs. According to an embodiment, the communication circuit 610 and the processor 620 may be integrated to be implemented as a single physical chip.

The processor 620 may control the communication circuit 610 such that the short-range wireless communication is activated according to the activation of a service using the short-range wireless communication. According to an example, the service using the short-range wireless communication may include a service configured to transmit data (or contents) temporarily or non-temporarily stored in the first electronic device 511 to the second electronic device (e.g., the second electronic device 521 of FIG. 5A). The processor 620 may control the communication circuit 610 such that the short-range wireless communication is activated when an application capable of performing a service using the short-range wireless communication is executed or when an application capable of performing a service using the short-range wireless communication is requested to perform a service using the short-range wireless communication.

The processor 620 may control the communication circuit 610 such that a series of operations of searching for the second electronic device 521 to be connected via the first communication method of the short-range wireless communication is performed according to the activation of the short-range wireless communication.

Searching for the second electronic device 521 to be connected via the first communication method may include receiving a discovery message, which is a signal transmitted (or broadcasted) by the second electronic device 521. The signal transmitted by the second electronic device 521 may be a signal for the second electronic device 521 to search for an electronic device (e.g., the first electronic device 511) to be connected via the first communication method. According to an example, the discovery message, which is a signal transmitted by the second electronic device 521, may include a probe request frame defined in IEEE 802.11 WLAN. The discovery message may include various information. According to an example, the discovery message may include information related to the second electronic device 521.

The processor 620 may control the communication circuit 610 such that signals of various frequency bands are received to search for the second electronic device 521 to be connected via the first communication method. According to an example, the processor 620 may control the communication circuit 610 such that a signal of the first frequency band is received and, may wait for reception of a discovery message, which is a signal transmitted (or broadcasted) by the second electronic device 521, for a designated time. When the processor 620 fails to receive a signal transmitted (or broadcasted) by the second electronic device 521 via the first frequency band, the processor 620 may wait for reception of a discovery message transmitted (or broadcasted) by the second electronic device 521 via a second frequency band, which is a frequency band different from the first frequency band.

The processor 620 may establish a connection with the second electronic device 521 via short-range wireless communication when receiving a discovery message transmitted (or broadcasted) by the second electronic device 521.

The processor 620 may identify whether the discovery message transmitted by the second electronic device 521 includes information related to the second communication method. The information related to the second communication method may include an information element (e.g., NAN information element (IE)) of the second communication method. The information element of the second communication method may include various information on the second communication method. According to an example, the information element of the second communication method may include capability information related to the second communication method and/or information indicating whether the second electronic device 521 supports the second communication method. Alternatively, the information element of the second communication method may include at least one of master indication information, cluster information, service identifier list information, service descriptor information, connection capability information, wireless LAN infrastructure information, peer to peer (P2P) operation information, independent basic service set (IBSS) information, mesh information, further proximity network service discovery information, further availability map information, country code information, ranging information, cluster discovery information, or vendor specific information.

The processor 620 may establish a connection with the second electronic device 521 via either the first communication method or the second communication method, based on whether the discovery message transmitted by the second electronic device 521 includes information related to the second communication method.

According to an example, the processor 620 may control the communication circuit 610 such that a connection with the second electronic device 521 via the first communication method is established, based on that information related to the second communication method is not included in the discovery message transmitted by the second electronic device 521. Alternatively, the processor 620 may control the communication circuit 610 such that a connection with the second electronic device 521 is established via the first communication method, based on that information indicating that the second electronic device 521 does not support the second communication method or cannot be connected via the second communication method is included in the discovery message transmitted by the second electronic device 521. Alternatively, the processor 620 may control the communication circuit 610 such that a connection with the second electronic device 521 is established via the first communication method, based on that the discovery message transmitted by the second electronic device 521 includes information indicating that the second electronic device 521 supports the second communication method and includes information indicating that the second electronic device 521 cannot be connected via the second communication method.

According to an example, the processor 620 may control the communication circuit 610 such that a connection with the second electronic device 521 is established via the second communication method, based on that information related to the second communication method is included in the discovery message transmitted by the second electronic device 521. Alternatively, the processor 620 may control the communication circuit 610 such that a connection with the second electronic device 521 is established via the second communication method, based on that information indicating that the second electronic device 521 supports the second communication method is included in the discovery message transmitted by the second electronic device 521.

The processor 620 may determine to establish a connection with the second electronic device 521 via the second communication method and activate an interface for performing the second communication method. The interface using the second communication method may include a hardware interface (e.g., the communication circuit 610) and/or a software interface (e.g., an interface for processing data via the second communication method).

The processor 620 may generate (or activate) a cluster of the second communication method (e.g., the first cluster 510 of FIG. 5A) as part of an operation of performing the second communication method. The processor 620 may perform configuration related to a discovery window of the first cluster 510 as part of an operation of performing the second communication method. The configuration related to the discovery window may include a starting time point of the discovery window, an activation duration of the discovery window, and/or a duration of the discovery window.

According to an example, in performing configuration related to the discovery window of the first cluster 510, the processor 620 may refer to a timing synchronization function (TSF), which is a synchronization function defined in the first communication method. The TSF may be an arbitrary value used for synchronization in the first communication method. For example, the first electronic device 511 may transmit a TSF to the second electronic device 521, and the first electronic device 511 and the second electronic device 521 may configure a counter used for synchronization, based on the TSF value. When the first electronic device 511 and the second electronic device 521 configure a counter using the same TSF value, the first electronic device 511 and the second electronic device 521 may activate data transmission and/or reception durations at substantially the same time.

The processor 620 may configure such that the discovery window period and/or duration is identical to the discovery window period and/or duration value defined in the NAN of the IEEE 802.11 WLAN and may configure, as a starting time point of the discovery window, a value obtained by applying an offset to the starting time point of the activation duration for data transmission and/or reception using the first communication method, which is determined by the TSF of the first communication method.

The processor 620 may configure such that the activation duration of the discovery window is identical to the period of the activation duration of data transmission and/or reception using the first communication method, which is determined using the TSF of the first communication method. The processor 620 may configure such that the size of the activation duration of data transmission and/or reception using the first communication method, which is determined using the TSF of the first communication method, is identical to the size of the duration of the discovery window. The processor 620 may configure, as a starting time point of the discovery window, a value obtained by applying an offset to a starting time point of an activation duration of data transmission and/or reception using the first communication method, which is determined using the TSF of the first communication method.

The processor 620 may control the communication circuit 610 such that a response message to the discovery message is transmitted to the second electronic device 521 via the first communication method. The response message to the discovery message may include a probe response frame defined in IEEE 802.11 WLAN. The response message to the discovery message may include synchronization information related to the first communication method. The synchronization information related to the first communication method may include a TSF of the first communication method.

The response message to the discovery message may include information for performing short-range wireless communication via the second communication method.

The information for performing short-range wireless communication via the second communication method may include information related to the first cluster 510. According to an example, information related to the first cluster 510 may include various information including identification information (or identifier) of the first cluster 510 and/or a NAN management interface address.

The information for performing short-range wireless communication via the second communication method may include information for synchronization between electronic devices to be included in the first cluster 510. The information for synchronization between electronic devices to be included in the first cluster 510 may include parameters related to synchronization configured (or determined) by the processor 620. According to an example, the parameters related to synchronization may include a starting time point of a discovery window of the first cluster 510, an interval of the discovery window of the first cluster 510, and/or a duration of the discovery window of the first cluster 510.

The processor 620 may transmit a response message, including a TSF of the first communication method and an offset for determining a starting time point of a discovery window of the first cluster 510, to the second electronic device 521 via the first communication method. The offset may be included in the TSF of the first communication method. The offset may be configured in some of the designated bits (e.g., 64 bits) allocated to the TSF of the first communication method. In an example, the offset may be configured in 23 bits of the 64 bit TSF.

Accordingly, the second electronic device 521 may receive information for synchronization of the first cluster 510 before activation of the second communication method and may reduce the latency of data transmission and/or reception via the second communication method. After completing synchronization of the first cluster 510, the second electronic device 521 may transmit data to the first electronic device 511 via the second communication method. Alternatively, the second electronic device 521 may not activate the communication circuit for data transmission and/or reception during the discovery window duration of the first cluster 510 after completing synchronization of the first cluster 510. In this case, the second electronic device 521 may maintain the synchronization state of the first cluster 510 and activate the communication circuit during the discovery window duration of the first cluster 510 when data transmission and/or reception occurs.

The processor 620 may transmit a response message further including configuration information of a data path of the second communication method to the second electronic device 521 via the first communication method, based on whether the second electronic device 521 has requested a data communication service via the second communication method.

The configuration information of the data path of the second communication method may include parameters for configuring a NAN data path (NDP), which is a path for exchanging the service discovery frame (SDF) and/or data, which may be exchanged in the discovery duration of the second communication method.

The processor 620 may identify that information indicating a request for a data communication service via the second communication method is included in the discovery message transmitted by the second electronic device 521, and may transmit, to the second electronic device 521 via the first communication method, a response message including information for synchronization between electronic devices to be included in the first cluster 510 and configuration information of the data path of the second communication method.

The processor 620 may identify that information indicating a request for a data communication service via the second communication method is not included in the discovery message transmitted by the second electronic device 521, and may transmit a response message including information for synchronization between electronic devices to be included in the first cluster 510 to the second electronic device 521 via the first communication method.

According to an embodiment, the second electronic device 521 may receive configuration information of a data path of the second communication method before activation of the second communication method and may reduce the latency of data transmission and/or reception via the second communication method. For example, since the configuration information of a data path of the second communication method is received before synchronization with the first cluster 510 is completed, the second electronic device 521 may transmit data to the first electronic device 511 via the second communication method or receive data transmitted by the first electronic device 511 after synchronization with the first cluster 510 is completed. Therefore, the latency of data transmission and/or reception via the second communication method may be reduced.

After a response message is transmitted to the second electronic device 521 via the first communication method, the processor 620 may establish a connection with the second electronic device 521 via the second communication method upon receiving a signal (e.g., ACK) indicating that the response message has been received within a designated time.

After a response message is transmitted to the second electronic device 521 via the first communication method, the processor 620 may establish a connection with the second electronic device 521 via the first communication method rather than the second communication method upon failing to receive a signal (e.g., ACK) indicating that the response message has been received within a designated time. Alternatively, the processor 620 may establish a connection with the second electronic device 521 via the second communication method regardless of receiving a signal indicating that the response message has been received.

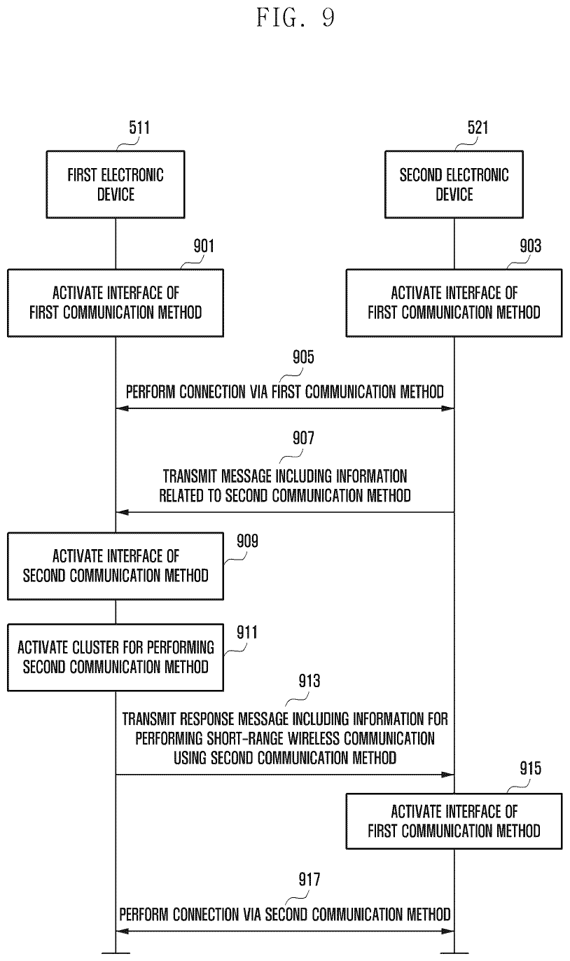

The above-described embodiment may be implemented while the first electronic device 511 is establishing a connection with the second electronic device 521 via the first communication method. However, the disclosure may also be implemented after the first electronic device 511 is completed connecting with the second electronic device 521 via the first communication method. A specific example will be described later in FIG. 9.

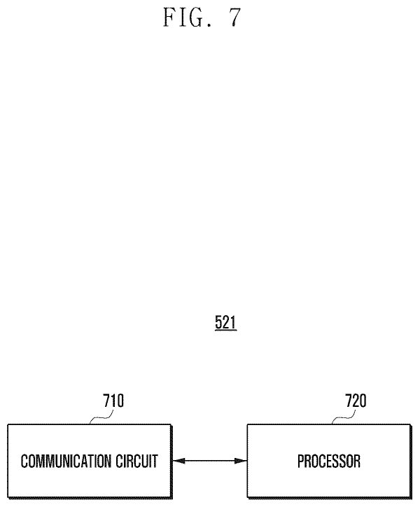

FIG. 7 illustrates a second electronic device according to various embodiments of the disclosure.

The second electronic device 521 (e.g., the second electronic device 521 of FIG. 5A) may include a communication circuit 710 (e.g., the wireless communication module 192 of FIG. 1) and a processor 720 (e.g., the processor 120 of FIG. 1).

The communication circuit 710 may include various circuit structures used for modulating and/or demodulating signals within the first electronic device 600. For example, the communication circuit 710 may modulate a baseband signal into a radio frequency (RF) signal to be output through an antenna (not shown) or may demodulate an RF signal received through an antenna into a baseband signal and transmit the same to the processor 720.

The communication circuit 710 may transmit or receive various data to or from an external electronic device via a frequency band (e.g., 2.4 GHz, 5 GHz, and/or 6 GHz) supported by short-range wireless communication. According to an example, the short-range wireless communication may include Wi-Fi defined in IEEE 802.11 WLAN.

The communication circuit 710 may support a first communication method of short-range wireless communication. The first communication method may include device to device communication (D2D) among short-range wireless communication. According to an example, the first communication method may include Wi-Fi direct, Bluetooth, or Bluetooth low energy (BLE).

The communication circuit 710 may support a second communication method of short-range wireless communication. The second communication method may refer to cluster-based communication among short-range wireless communication. The cluster-based communication may refer to communication in which electronic devices included in a cluster are synchronized and the electronic devices included in the cluster exchange data during the same time (e.g., discovery window). According to an example, the second communication method may include a neighbor awareness network (NAN) among short-range wireless communication.

The communication circuit 710 may be connected to various external electronic devices via the first communication method and/or the second communication method, based on the control of the processor 720. Alternatively, the communication circuit 710 may be connected to another external electronic device via the second communication method while being connected to an external electronic device via the first communication method.

The processor 720 may perform an operation of receiving data transmitted by an application processor (e.g., the processor 120 of FIG. 1) and generating a packet for transmitting the received data to an external electronic device. The processor 720 may be defined as a communication processor (or a communication processor) included in a communication module (e.g., the wireless communication module 192 of FIG. 1). According to an embodiment, the processor 720 may perform channel coding based on the data transmitted by the application processor (e.g., the application processor 120 of FIG. 1), thereby generating a packet, determining whether at least a part of data transmitted by an external electronic device (e.g., the first electronic device 511 of FIG. 5A) has an error, or performing an operation of recovering the error (e.g., hybrid auto repeat request (HARQ)) when an error occurs. According to an embodiment, the communication circuit 710 and the processor 720 may be integrated to be implemented as a single physical chip.

The processor 720 may control the communication circuit 710 such that the short-range wireless communication is activated according to the activation of a service using the short-range wireless communication. According to an example, the service using the short-range wireless communication may include a service configured to transmit data (or contents) temporarily or non-temporarily stored in the first electronic device 511 to the second electronic device (e.g., the second electronic device 521 of FIG. 5A). The processor 720 may control the communication circuit 710 such that the short-range wireless communication is activated when an application capable of performing a service using the short-range wireless communication is executed or when an application capable of performing a service using the short-range wireless communication is requested to perform a service using the short-range wireless communication.

The processor 720 may control the communication circuit 710 such that a series of operations of searching for the first electronic device 511 to be connected via the first communication method of the short-range wireless communication is performed according to the activation of the short-range wireless communication.

Searching for the first electronic device 511 to be connected via the first communication method may include transmitting a discovery message to the first electronic device 511. The signal transmitted by the second electronic device 521 may be a signal for the second electronic device 521 to search for an electronic device (e.g., the first electronic device 511) to be connected via the first communication method. According to an example, the discovery message, which is a signal transmitted by the second electronic device 521, may include a probe request frame defined in IEEE 802.11 WLAN. The discovery message may include various information. According to an example, the discovery message may include information related to the second electronic device 521.

The processor 720 may transmit a discovery message including information related to the second communication method when the communication circuit 710 allows for support of a connection via the second communication method. The information related to the second communication method may include an information element (e.g., a NAN information element (IE)) of the second communication method. The information element of the second communication method may include various information on the second communication method. According to an example, the information element of the second communication method may include capability information related to the second communication method and/or information indicating whether the second electronic device 521 supports the second communication method. Alternatively, the information element of the second communication method may include at least one of master indication information, cluster information, service identifier list information, service descriptor information, connection capability information, wireless LAN infrastructure information, peer to peer (P2P) operation information, independent basic service set (IBSS) information, mesh information, further proximity network service discovery information, further availability map information, country code information, ranging information, cluster discovery information, or vendor specific information.

As described in FIG. 6, the first electronic device 511 may receive a discovery message including information related to the second communication method and perform a series of operations to establish a connection with the second electronic device 521 via the second communication method.

As part of the operation of performing the second communication method, the first electronic device 511 may generate (or activate) a cluster of the second communication method (e.g., the first cluster 510 of FIG. 5A). As part of the operation of performing the second communication method, the first electronic device 511 may perform configuration related to a discovery window of the first cluster 510. The configuration related to the discovery window may include a starting time point of the discovery window, an activation cycle of the discovery window, and/or a duration of the discovery window.

According to an example, in performing configuration related to the discovery window of the first cluster 510, the first electronic device 511 may refer to a timing synchronization function (TSF), which is a synchronization function defined in the first communication method. The TSF may be an arbitrary value used for synchronization in the first communication method. For example, the first electronic device 511 may transmit the TSF to the second electronic device 521, and the first electronic device 511 and the second electronic device 521 may configure a counter used for synchronization, based on the TSF value. When the first electronic device 511 and the second electronic device 521 configure a counter using the same TSF value, the data transmission and/or reception duration may be activated at substantially the same time.

The first electronic device 511 may configure such that the period and/or duration of the discovery window is identical to the period and/or duration value of the discovery window defined in the NAN of the IEEE 802.11 WLAN, and may configure, as a starting time point of the discovery window, a value obtained by applying an offset to a starting time point of an activation duration of data transmission and/or reception using the first communication method, which is determined using the TSF of the first communication method.

The first electronic device 511 may configure such that the activation period of the discovery window is identical to the period of the activation duration of data transmission and/or reception using the first communication method, which is determined using the TSF of the first communication method. The first electronic device 511 may configure such that the size of the activation duration of data transmission and/or reception using the first communication method, which is determined using the TSF of the first communication method, is identical to the size of the duration of the discovery window. The first electronic device 511 may configure, as a starting time point of the discovery window, a value obtained by applying an offset to the starting time point of the activation duration of data transmission and/or reception using the first communication method, which is determined using the TSF of the first communication method.

The first electronic device 511 may transmit a response message to the discovery message to the second electronic device 521.

The processor 720 may receive a response message to a discovery message and determine whether information for performing short-range wireless communication via the second communication method is included in the response message.

Information for performing short-range wireless communication via the second communication method may include information related to the first cluster 510. According to an example, information related to the first cluster 510 may include various information including identification information (or identifier) of the first cluster 510 and/or a NAN management interface address.

The information for performing short-range wireless communication via the second communication method may include information for synchronization between electronic devices to be included in the first cluster 510. The information for synchronization between electronic devices to be included in the first cluster 510 may include parameters related to synchronization configured (or determined) by the first electronic device 511. In an example, the parameters related to synchronization may include a starting time point of a discovery window of the first cluster 510, an interval of the discovery window of the first cluster 510, and/or a duration of the discovery window of the first cluster 510.

The processor 720 may determine whether to perform short-range wireless communication via the second communication method, based on whether information for performing short-range wireless communication via the second communication method is included in the response message to the discovery message.

According to an example, the processor 720 may determine to perform short-range wireless communication via the first communication method, based on that the response message to the discovery message does not include information for performing short-range wireless communication via the second communication method.

According to an Example, the Processor 720 May Determine to Perform Short-range wireless communication via the second communication method, based on that information for performing short-range wireless communication via the second communication method is included in the response message to the discovery message.

Upon receiving a response message including information for performing short-range wireless communication via the second communication method, the processor 720 may control the communication circuit 710 such that a signal indicating that the response message has been received is transmitted to the first electronic device 511.

The processor 720 may perform, upon determining to perform short-range wireless communication via the second communication method, synchronization with the first cluster 510, based on the TSF of the first communication method and the offset for determining the starting time point of the discovery window of the first cluster 510, both included in the response message.

Accordingly, the second electronic device 521 may receive information for synchronization of the first cluster 510 before activation of the second communication method and may reduce the latency of data transmission and/or reception via the second communication method.

When the processor 720 may configure, upon determining to perform short-range wireless communication via the second communication method, an NDP, which is a path for exchanging data, based on the configuration information of the data path of the second communication method included in the response message.

The configuration information of the data path of the second communication method may include parameters for configuring the NAN data path (NDP), which is a path for exchanging the service discovery frame (SDF) and/or data, which may be exchanged in the discovery duration of the second communication method.

The second electronic device 521 may receive the configuration information of the data path of the second communication method before activation of the second communication method and may reduce the latency of data transmission and/or reception via the second communication method. For example, since the configuration information of the data path of the second communication method is received before the synchronization with the first cluster 510 is completed, the second electronic device 521 may transmit data to the first electronic device 511 via the second communication method or receive data transmitted by the first electronic device 511 after the synchronization with the first cluster 510 is completed. Therefore, the latency of data transmission and/or reception via the second communication method may be reduced.

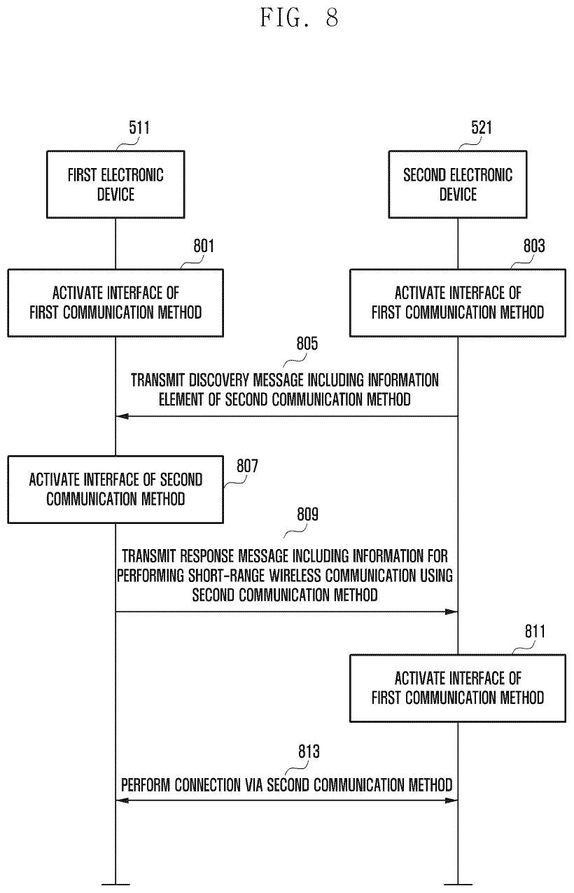

FIG. 8 illustrates an embodiment in which a first electronic device and a second electronic device are connected via a second communication method before being connected via a first communication method, according to an embodiment.

In operation 801, the first electronic device (e.g., the first electronic device 511 of FIG. 5A) may activate an interface of the first communication method.

The first electronic device 511 may control a communication circuit (e.g., the communication circuit 610 of FIG. 6) such that short-range wireless communication is activated according to the activation of a service using short-range wireless communication. According to an example, the service using short-range wireless communication may include a service configured to transmit data (or contents) temporarily or non-temporarily stored in the first electronic device 511 to a second electronic device (e.g., the second electronic device 521 of FIG. 5A). The first electronic device 511 may control the communication circuit 610 such that the short-range wireless communication is activated when an application capable of performing a service using the short-range wireless communication is executed or when an application capable of performing a service using the short-range wireless communication is requested to perform a service using the short-range wireless communication.

The first communication method may include device to device communication (D2D) among short-range wireless communication. According to an example, the first communication method may include Wi-Fi direct, Bluetooth, or Bluetooth low energy (BLE). The first electronic device 511 may activate an interface of the first communication method and search for the second electronic device 521 to be connected via the first communication method.

In operation 803, the second electronic device (e.g., the second electronic device 521 of FIG. 5A) may activate an interface of the first communication method.

The second electronic device 521 may control a communication circuit (e.g., the communication circuit 710 of FIG. 7) such that short-range wireless communication is activated according to the activation of a service using short-range wireless communication. According to an example, the service using short-range wireless communication may include a service configured to transmit data (or contents) temporarily or non-temporarily stored in the first electronic device 511 to a second electronic device (e.g., the second electronic device 521 of FIG. 5A). The second electronic device 521 may control the communication circuit 710 such that the short-range wireless communication is activated when an application capable of performing a service using the short-range wireless communication is executed or when an application capable of performing a service using the short-range wireless communication is requested to perform a service using the short-range wireless communication.

In operation 805, the second electronic device 521 may transmit a discovery message including an information element of the second communication method to the first electronic device 511.

The second electronic device 521 may activate an interface of the first communication method and search for the first electronic device 511 to be connected via the first communication method. Searching for the first electronic device 511 to be connected via the first communication method may include transmitting a discovery message to the first electronic device 511. The signal transmitted by the second electronic device 521 may be a signal for the second electronic device 521 to search for an electronic device (e.g., the first electronic device 511) to be connected via the first communication method. According to an example, the discovery message, which is a signal transmitted by the second electronic device 521, may include a probe request frame defined in IEEE 802.11 WLAN. The discovery message may include various information. According to an example, the discovery message may include information related to the second electronic device 521.

The second electronic device 521 may transmit a discovery message including information related to the second communication method when the communication circuit 710 allows for support of a connection via the second communication method. The information related to the second communication method may include an information element (e.g., a NAN information element (IE)) of the second communication method. The information element of the second communication method may include various information on the second communication method. According to an example, the information element of the second communication method may include capability information related to the second communication method and/or information indicating whether the second electronic device 521 supports the second communication method. Alternatively, the information element of the second communication method may include at least one of master indication information, cluster information, service identifier list information, service descriptor information, connection capability information, wireless LAN infrastructure information, peer to peer (P2P) operation information, independent basic service set (IBSS) information, mesh information, further proximity network service discovery information, further availability map information, country code information, ranging information, cluster discovery information, or vendor specific information.

In operation 807, the first electronic device 511 may activate an interface of the second communication method.

The first electronic device 511 may identify whether information related to the second communication method is included in the discovery message transmitted by the second electronic device 521. The information related to the second communication method may include an information element (e.g., NAN information element (IE)) of the second communication method.

According to an example, the first electronic device 511 may control the communication circuit 610 such that a connection with the second electronic device 521 is established via the second communication method, based on that information related to the second communication method is included in the discovery message transmitted by the second electronic device 521. Alternatively, the first electronic device 511 may control the communication circuit 610 such that a connection with the second electronic device 521 is established via the second communication method, based on that information indicating that the second electronic device 521 supports the second communication method is included in the discovery message transmitted by the second electronic device 521.

The first electronic device 511 may determine to establish a connection with the second electronic device 521 via the second communication method and may activate an interface for performing the second communication method. The interface using the second communication method may include a hardware interface (e.g., a communication circuit 610) and/or a software interface (e.g., an interface for processing data via the second communication method).

The first electronic device 511 may generate (or activate) a cluster of the second communication method (e.g., the first cluster 510 of FIG. 5A) as part of the operation for performing the second communication method. The first electronic device 511 may perform configuration related to a discovery window of the first cluster 510 as part of the operation for performing the second communication method. Configuration related to a discovery window may include a starting time point of the discovery window, an activation period for the discovery window, and/or a duration for the discovery window.

According to an example, in performing settings related to the discovery window of the first cluster 510, the first electronic device 511 may refer to a timing synchronization function (TSF), which is a synchronization function defined in the first communication method. The TSF may be an arbitrary value used for synchronization in the first communication method. For example, the first electronic device 511 may transmit the TSF to the second electronic device 521, and the first electronic device 511 and the second electronic device 521 may configure a counter used for synchronization, based on the TSF value. When the first electronic device 511 and the second electronic device 521 configure a counter using the same TSF value, the data transmission and/or reception durations may be activated at substantially the same time.

The first electronic device 511 may configure such that the period and/or duration of the discovery window is identical to the period and/or duration value of the discovery window defined in the NAN of the IEEE 802.11 WLAN, and may configure, as a starting time point of the discovery window, a value obtained by applying an offset to a starting time point of an activation duration of data transmission and/or reception using the first communication method, which is determined using the TSF of the first communication method.

The first electronic device 511 may configure such that the activation period of the discovery window is identical to the period of the activation duration of data transmission and/or reception using the first communication method, which is determined using the TSF of the first communication method. The first electronic device 511 may configure such that the size of the activation duration of data transmission and/or reception using the first communication method, which is determined using the TSF of the first communication method, is identical to the size of the duration of the discovery window. The first electronic device 511 may configure, as a starting time point of the discovery window, a value obtained by applying an offset to a starting time point of the activation duration of data transmission and/or reception using the first communication method, which is determined using the TSF of the first communication method.

In operation 809, the first electronic device 511 may transmit a response message including information for performing short-range wireless communication using the second communication method to the second electronic device 521.

The first electronic device 511 may control the communication circuit 610 such that a response message to the discovery message is transmitted to the second electronic device 521 via the first communication method. The response message to the discovery message may include a probe response frame defined in IEEE 802.11 WLAN. The response message to the discovery message may include synchronization information related to the first communication method. The synchronization information related to the first communication method may include a TSF of the first communication method.

The response message to the discovery message may include information for performing short-range wireless communication via the second communication method.

The information for performing short-range wireless communication via the second communication method may include information related to the first cluster 510. According to an example, information related to the first cluster 510 may include various information including identification information (or identifier) of the first cluster 510 and/or a NAN management interface address.

The information for performing short-range wireless communication via the second communication method may include information for synchronization between electronic devices to be included in the first cluster 510. The information for synchronization between electronic devices to be included in the first cluster 510 may include parameters related to synchronization configured (or determined) by the first electronic device 511. According to an example, the parameters related to synchronization may include a starting time point of a discovery window of the first cluster 510, an interval of the discovery window of the first cluster 510, and/or a duration of the discovery window of the first cluster 510.

The first electronic device 511 may transmit a response message, including a TSF of the first communication method and an offset for determining a starting time point of a discovery window of the first cluster 510, to the second electronic device 521 via the first communication method. The offset may be included in the TSF of the first communication method. The offset may be configured in some of the designated bits (e.g., 64 bits) allocated to the TSF of the first communication method. In an example, the offset may be configured in 23 bits of the 64-bit TSF.

Accordingly, the second electronic device 521 may receive information for synchronizing the first cluster 510 before activation of the second communication method and may reduce the latency of data transmission and/or reception via the second communication method.

The first electronic device 511 may transmit a response message further including configuration information of a data path of the second communication method to the second electronic device 521 via the first communication method, based on whether the second electronic device 521 has requested a data communication service via the second communication method.

The configuration information of the data path of the second communication method may include parameters for configuring the NAN data path (NDP), which is a path for exchanging the service discovery frame (SDF) and/or data, which may be exchanged in the discovery duration of the second communication method.

The first electronic device 511 may identify that information indicating a request for a data communication service via the second communication method is included in the discovery message transmitted by the second electronic device 521, and may transmit, to the second electronic device 521 via the first communication method, a response message including information for synchronization between electronic devices to be included in the first cluster 510 and configuration information of the data path of the second communication method.

The first electronic device 511 may identify that information indicating a request for a data communication service via the second communication method is not included in the discovery message transmitted by the second electronic device 521 and may transmit a response message including information for synchronization between electronic devices to be included in the first cluster 510 to the second electronic device 521 via the first communication method.

In operation 811, the second electronic device 521 may activate an interface of the second communication method upon receiving a response message.

The second electronic device 521 may receive the response message to the discovery message and determine whether information for performing short-range wireless communication via the second communication method is included in the response message.

The information for performing short-range wireless communication via the second communication method may include information related to the first cluster 510.

According to an example, the second electronic device 521 may determine to perform short-range wireless communication via the second communication method, based on that information for performing short-range wireless communication via the second communication method is included in the response message to the discovery message.

Upon determining to perform short-range wireless communication via the second communication method, the second electronic device 521 may perform synchronization with the first cluster 510, based on the TSF of the first communication method and the offset for determining a starting time point of the discovery window of the first cluster 510, both included in the response message.

Upon determining to perform short-range wireless communication via the second communication method, the second electronic device 521 may configure an NDP, which is a path for exchanging data, based on the configuration information of the data path of the second communication method included in the response message.

The configuration information of the data path of the second communication method may include parameters for configuring a NAN data path (NDP), which is a path for exchanging a service discovery frame (SDF) and/or data, which may be exchanged in the discovery duration of the second communication method.

In operation 813, the first electronic device 511 and the second electronic device 521 may establish a connection via the second communication method.

The second electronic device 521 according to an embodiment may receive configuration information of a data path of the second communication method before activation of the second communication method and may reduce the latency of data transmission and/or reception via the second communication method. For example, since the configuration information of the data path of the second communication method is received before synchronization with the first cluster 510 is completed, the second electronic device 521 may transmit data to the first electronic device 511 via the second communication method or receive data transmitted by the first electronic device 511 after synchronization with the first cluster 510 is completed. Therefore, the latency of data transmission and/or reception via the second communication method may be reduced.

FIG. 9 illustrates an embodiment in which a first electronic device and a second electronic device are connected via a second communication method while being connected via a first communication method, according to an embodiment.

In operation 901, the first electronic device (e.g., the first electronic device 511 of FIG. 5A) may activate an interface of the first communication method.

The first electronic device 511 may control a communication circuit (e.g., the communication circuit 610 of FIG. 6) such that short-range wireless communication is activated according to the activation of a service using short-range wireless communication. According to an example, the service using short-range wireless communication may include a service configured to transmit data (or contents) temporarily or non-temporarily stored in the first electronic device 511 to the second electronic device (e.g., the second electronic device 521 of FIG. 5A). The first electronic device 511 may control the communication circuit 610 such that short-range wireless communication is activated when an application capable of performing a service using the short-range wireless communication is executed or when an application capable of performing a service using the short-range wireless communication is requested to perform a service using the short-range wireless communication.

The first communication method may include device to device communication (D2D) among short-range wireless communication. According to an example, the first communication method may include Wi-Fi direct, Bluetooth, or Bluetooth low energy (BLE). The first electronic device 511 may activate an interface of the first communication method and search for the second electronic device 521 to be connected via the first communication method.

In operation 903, the second electronic device (e.g., the second electronic device 521 of FIG. 5A) may activate an interface of the first communication method.

The second electronic device 521 may control a communication circuit (e.g., the communication circuit 710 of FIG. 7) such that short-range wireless communication is activated according to the activation of a service using short-range wireless communication. According to an example, the service using short-range wireless communication may include a service configured to transmit data (or contents) temporarily or non-temporarily stored in the first electronic device 511 to the second electronic device (e.g., the second electronic device 521 of FIG. 5A). The second electronic device 521 may control the communication circuit 710 such that short-range wireless communication is activated when an application capable of performing a service using the short-range wireless communication is executed or when an application capable of performing a service using the short-range wireless communication is requested to perform a service using the short-range wireless communication.

In operation 905, the first electronic device 511 and the second electronic device 521 may establish a connection via the first communication method.

In operation 907, the second electronic device 521 may transmit a message including information related to the second communication method to the first electronic device 511 via the first communication method.

The information related to the second communication method may include an information element (e.g., NAN information element (IE)) of the second communication method. The information element of the second communication method may include various information on the second communication method. According to an example, the information element of the second communication method may include capability information related to the second communication method and/or information indicating whether the second electronic device 521 supports the second communication method. Alternatively, the information element of the second communication method may include at least one of master indication information, cluster information, service identifier list information, service descriptor information, connection capability information, wireless LAN infrastructure information, peer to peer (P2P) operation information, independent basic service set (IBSS) information, mesh information, further proximity network service discovery information, further availability map information, country code information, ranging information, cluster discovery information, or vendor specific information.

The information related to the second communication method may be included in various signals (e.g., a beacon signal, a probe request frame, and/or a probe response frame) defined in the first communication method.

In operation 909, the first electronic device 511 may activate an interface of the second communication method upon receiving information related to the second communication method.

According to an example, the first electronic device 511 may control the communication circuit 610 such that a connection with the second electronic device 521 is established via the second communication method, based on that information related to the second communication method is included in the message transmitted by the second electronic device 521. Alternatively, the first electronic device 511 may control the communication circuit 610 to establish a connection with the second electronic device 521 via the second communication method, based on that information indicating that the second electronic device 521 supports the second communication method is included in the message transmitted by the second electronic device 521.

The first electronic device 511 may determine to establish a connection with the second electronic device 521 via the second communication method and activate an interface for performing the second communication method. The interface using the second communication method may include a hardware interface (e.g., the communication circuit 610) and/or a software interface (e.g., an interface for processing data via the second communication method).

In operation 911, the first electronic device 511 may activate a cluster (e.g., the first cluster 510 of FIG. 5A) for performing the second communication method.

The first electronic device 511 may generate (or activate) a cluster (e.g., the first cluster 510 of FIG. 5A) of the second communication method as part of the operation for performing the second communication method. The first electronic device 511 may perform configuration related to a discovery window of the first cluster 510 as part of the operation for performing the second communication method. The configuration related to the discovery window may include a starting time point of the discovery window, an activation period of the discovery window, and/or a duration of the discovery window.

According to an example, in performing configuration related to the discovery window of the first cluster 510, the first electronic device 511 may refer to a timing synchronization function (TSF), which is a synchronization function defined in the first communication method. The TSF may be an arbitrary value used for synchronization in the first communication method. For example, the first electronic device 511 may transmit a TSF to the second electronic device 521, and the first electronic device 511 and the second electronic device 521 may configure a counter used for synchronization, based on the TSF value. When the first electronic device 511 and the second electronic device 521 configure a counter using the same TSF value, the first electronic device 511 and the second electronic device 521 may activate data transmission and/or reception durations at substantially the same time.

The first electronic device 511 may configure such that the discovery window period and/or duration is identical to the discovery window period and/or duration value defined in the NAN of the IEEE 802.11 WLAN and may configure, as a starting time point of the discovery window, a value obtained by applying an offset to the starting time point of the activation duration for data transmission and/or reception using the first communication method, which is determined by the TSF of the first communication method.

The first electronic device 511 may configure such that the activation duration of the discovery window is identical to the period of the activation duration of data transmission and/or reception using the first communication method, which is determined using the TSF of the first communication method. The first electronic device 511 may configure such that the size of the activation duration of data transmission and/or reception using the first communication method, which is determined using the TSF of the first communication method, is identical to the size of the duration of the discovery window. The first electronic device 511 may configure, as a starting time point of the discovery window, a value obtained by applying an offset to a starting time point of an activation duration of data transmission and/or reception using the first communication method, which is determined using the TSF of the first communication method.

When the first electronic device 511 is connected to another external electronic device via the second communication method, the operation of activating a cluster (operation 911) may be omitted.

In operation 913, the first electronic device 511 may transmit a response message including information for performing short-range wireless communication using the second communication method to the second electronic device 521 via the first communication method.

The first electronic device 511 may control the communication circuit 610 such that a response message to the discovery message is transmitted to the second electronic device 521 via the first communication method. The response message to the discovery message may include a probe response frame defined in IEEE 802.11 WLAN. The response message to the discovery message may include synchronization information related to the first communication method. The synchronization information related to the first communication method may include a TSF of the first communication method.

The response message to the discovery message may include information for performing short-range wireless communication via the second communication method.

The information for performing short-range wireless communication via the second communication method may include information related to the first cluster 510. According to an example, the information related to the first cluster 510 may include various information including identification information (or identifier) of the first cluster 510 and/or a NAN management interface address.

The information for performing short-range wireless communication via the second communication method may include information for synchronization between electronic devices to be included in the first cluster 510. The information for synchronization between electronic devices to be included in the first cluster 510 may include parameters related to synchronization configured (or determined) by the first electronic device 511. According to an example, the parameters related to synchronization may include a starting time point of a discovery window of the first cluster 510, an interval of the discovery window of the first cluster 510, and/or a duration of the discovery window of the first cluster 510.

The first electronic device 511 may transmit a response message, including a TSF of the first communication method and an offset for determining a starting time point of a discovery window of the first cluster 510, to the second electronic device 521 via the first communication method. The offset may be included in the TSF of the first communication method. The offset may be configured in some of the designated bits (e.g., 64 bits) allocated to the TSF of the first communication method. In an example, the offset may be configured in 23 bits of the 64-bit TSF.

Accordingly, the second electronic device 521 may receive information for synchronizing the first cluster 510 before activation of the second communication method and may reduce the latency of data transmission and/or reception via the second communication method.

The first electronic device 511 may transmit a response message further including configuration information of a data path of the second communication method to the second electronic device 521 via the first communication method, based on whether the second electronic device 521 has requested a data communication service via the second communication method.

The configuration information of the data path of the second communication method may include parameters for configuring a NAN data path (NDP), which is a path for exchanging the service discovery frame (SDF) and/or data, which may be exchanged in the discovery section of the second communication method.

The first electronic device 511 may identify that information indicating a request for a data communication service via the second communication method is included in the discovery message transmitted by the second electronic device 521, and may transmit, to the second electronic device 521 via the first communication method, a response message including information for synchronization between electronic devices to be included in the first cluster 510 and configuration information of the data path of the second communication method.

The first electronic device 511 may identify that information indicating a request for a data communication service via the second communication method is not included in the discovery message transmitted by the second electronic device 521 and may transmit, to the second electronic device 521 via the first communication method, a response message including information for synchronization between electronic devices to be included in the first cluster 510.

In operation 915, the second electronic device 521 may activate an interface of the second communication method upon receiving a response message.

The second electronic device 521 may receive a response message to the discovery message and determine whether information for performing short-range wireless communication via the second communication method is included in the response message.

The information for performing short-range wireless communication via the second communication method may include information related to the first cluster 510.

According to an example, based on that information for performing short-range wireless communication via the second communication method is included in the response message to the discovery message, the second electronic device 521 may determine to perform short-range wireless communication via the second communication method.

Upon determining to perform short-range wireless communication via the second communication method, the second electronic device 521 may perform synchronization with the first cluster 510, based on the TSF of the first communication method and the offset for determining the starting time point of the discovery window of the first cluster 510, both included in the response message.

Upon determining to perform short-range wireless communication via the second communication method, the second electronic device 521 may configure an NDP, which is a path for exchanging data, based on the configuration information of the data path of the second communication method included in the response message.

The configuration information of the data path of the second communication method may include parameters for configuring a NAN data path (NDP), which is a path for exchanging service discovery frames (SDFs) and/or data, which may be exchanged in the discovery duration of the second communication method.

In operation 917, the first electronic device 511 and the second electronic device 521 may establish a connection via the second communication method.

The second electronic device 521 may receive the configuration information of the data path of the second communication method before activation of the second communication method and may reduce the latency of data transmission and/or reception via the second communication method. For example, since the configuration information of the data path of the second communication method is received before the synchronization with the first cluster 510 is completed, the second electronic device 521 may transmit data to the first electronic device 511 via the second communication method or receive data transmitted by the first electronic device 511 after the synchronization with the first cluster 510 is completed. Therefore, the latency of data transmission and/or reception via the second communication method may be reduced.

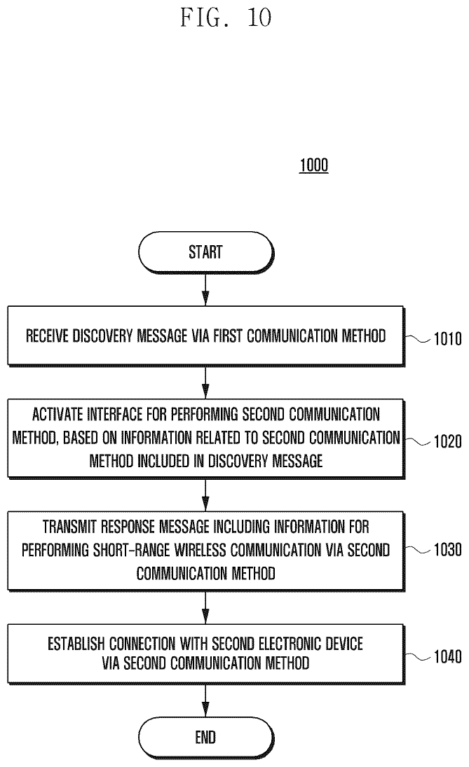

FIG. 10 is an operation flowchart 1000 illustrating an operation method of an electronic device according to an embodiment.

A first electronic device (e.g., the first electronic device 511 of FIG. 5A) may, in operation 1010, receive a discovery message from a second electronic device (e.g., the second electronic device 521 of FIG. 5A) via a first communication method.

The first electronic device 511 may control the communication circuit 610 such that short-range wireless communication is activated according to the activation of a service using short-range wireless communication. According to an example, the service using short-range wireless communication may include a service configured to transmit data (or contents) temporarily or non-temporarily stored in the first electronic device 511 to a second electronic device (e.g., the second electronic device 521 of FIG. 5A). The first electronic device 511 may control the communication circuit 610 such that the short-range wireless communication is activated when an application capable of performing a service using the short-range wireless communication is executed or when an application capable of performing a service using the short-range wireless communication is requested to perform a service using the short-range wireless communication.

The first electronic device 511 may control the communication circuit 610 such that a series of operations of searching for the second electronic device 521 to be connected via the first communication method of the short-range wireless communication is performed according to the activation of the short-range wireless communication.

Searching for the second electronic device 521 to be connected via the first communication method may include receiving a discovery message, which is a signal transmitted (or broadcasted) by the second electronic device 521. The signal transmitted by the second electronic device 521 may be a signal for the second electronic device 521 to search for an electronic device (e.g., the first electronic device 511) to be connected via the first communication method. According to an example, the discovery message, which is a signal transmitted by the second electronic device 521, may include a probe request frame defined in IEEE 802.11 WLAN. The discovery message may include various information. According to an example, the discovery message may include information related to the second electronic device 521.

The first electronic device 511 may control the communication circuit 610 such that signals of various frequency bands are received, thereby searching for the second electronic device 521 to be connected via the first communication method. According to an example, the first electronic device 511 may control the communication circuit 610 such that a signal of the first frequency band is received, and may wait for reception of a discovery message, which is a signal transmitted (or broadcasted) by the second electronic device 521, for a designated time. When the first electronic device 511 fails to receive a signal transmitted (or broadcasted) by the second electronic device 521 via the first frequency band, the first electronic device 511 may wait for reception of a discovery message transmitted (or broadcasted) by the second electronic device 521 via a second frequency band, which is a frequency band different from the first frequency band.

In operation 1020, the first electronic device 511 may activate an interface for performing the second communication method, based on that information related to the second communication method is included in the discovery message.

The first electronic device 511 may identify whether information related to the second communication method is included in the discovery message transmitted by the second electronic device 521. The information related to the second communication method may include an information element (e.g., a NAN information element (IE)) of the second communication method. The information element of the second communication method may include various information on the second communication method. According to an example, the information element of the second communication method may include capability information related to the second communication method and/or information indicating whether the second electronic device 521 supports the second communication method. Alternatively, the information element of the second communication method may include at least one of master indication information, cluster information, service identifier list information, service descriptor information, connection capability information, wireless LAN infrastructure information, peer to peer (P2P) operation information, independent basic service set (IBSS) information, mesh information, further proximity network service discovery information, further availability map information, country code information, ranging information, cluster discovery information, or vendor specific information.

The first electronic device 511 may establish a connection with the second electronic device 521 via either the first communication method or the second communication method, based on whether information related to the second communication method is included in the discovery message transmitted by the second electronic device 521.

According to an example, the first electronic device 511 may control the communication circuit 610 such that a connection with the second electronic device 521 is established via the first communication method, based on that information related to the second communication method is not included in the discovery message transmitted by the second electronic device 521. Alternatively, the first electronic device 511 may control the communication circuit 610 such that a connection with the second electronic device 521 is established via the first communication method, based on that information indicating that the second electronic device 521 does not support the second communication method or cannot be connected via the second communication method is included in the discovery message transmitted by the second electronic device 521. Alternatively, the first electronic device 511 may control the communication circuit 610 such that a connection with the second electronic device 521 is established via the first communication method, based on that the discovery message transmitted by the second electronic device 521 includes information indicating that the second electronic device 521 supports the second communication method and includes information indicating that the second electronic device 521 cannot be connected via the second communication method.

According to an example, the first electronic device 511 may control the communication circuit 610 such that a connection with the second electronic device 521 is established via the second communication method, based on that information related to the second communication method is included in the discovery message transmitted by the second electronic device 521. Alternatively, the first electronic device 511 may control the communication circuit 610 such that a connection with the second electronic device 521 is established via the second communication method, based on that information indicating that the second electronic device 521 supports the second communication method is included in the discovery message transmitted by the second electronic device 521.

The first electronic device 511 may determine to establish a connection with the second electronic device 521 via the second communication method and activate an interface for performing the second communication method. The interface using the second communication method may include a hardware interface (e.g., the communication circuit 610) and/or a software interface (e.g., an interface for processing data via the second communication method).

The first electronic device 511 may generate (or activate) a cluster of the second communication method (e.g., the first cluster 510 of FIG. 5A) as part of an operation of performing the second communication method. The first electronic device 511 may perform configuration related to a discovery window of the first cluster 510 as part of an operation of performing the second communication method. The configuration related to the discovery window may include a starting time point of the discovery window, an activation duration of the discovery window, and/or a duration of the discovery window.

According to an example, in performing configuration related to the discovery window of the first cluster 510, the first electronic device 511 may refer to a timing synchronization function (TSF), which is a synchronization function defined in the first communication method. The TSF may be an arbitrary value used for synchronization in the first communication method. For example, the first electronic device 511 may transmit a TSF to the second electronic device 521, and the first electronic device 511 and the second electronic device 521 may configure a counter used for synchronization, based on the TSF value. When the first electronic device 511 and the second electronic device 521 configure a counter using the same TSF value, the first electronic device 511 and the second electronic device 521 may activate data transmission and/or reception durations at substantially the same time.

The first electronic device 511 may configure such that the discovery window period and/or duration is identical to the discovery window period and/or duration value defined in the NAN of the IEEE 802.11 WLAN and may configure, as a starting time point of the discovery window, a value obtained by applying an offset to the starting time point of the activation duration for data transmission and/or reception using the first communication method, which is determined by the TSF of the first communication method.

The first electronic device 511 may configure such that the activation duration of the discovery window is identical to the period of the activation duration of data transmission and/or reception using the first communication method, which is determined using the TSF of the first communication method. The first electronic device 511 may configure such that the size of the activation duration of data transmission and/or reception using the first communication method, which is determined using the TSF of the first communication method, is identical to the size of the duration of the discovery window. The first electronic device 511 may configure, as a starting time point of the discovery window, a value obtained by applying an offset to a starting time point of an activation duration of data transmission and/or reception using the first communication method, which is determined using the TSF of the first communication method.

In operation 1030, the first electronic device 511 may transmit a response message including information for performing short-range wireless communication via the second communication method to the second electronic device 521 via the first communication method.

The first electronic device 511 may control the communication circuit 610 such that a response message to the discovery message is transmitted to the second electronic device 521 via the first communication method. The response message to the discovery message may include a probe response frame defined in IEEE 802.11 WLAN. The response message to the discovery message may include synchronization information related to the first communication method. The synchronization information related to the first communication method may include a TSF of the first communication method.

The response message to the discovery message may include information for performing short-range wireless communication via the second communication method.

The information for performing short-range wireless communication via the second communication method may include information related to the first cluster 510. According to an example, information related to the first cluster 510 may include various information including identification information (or identifier) of the first cluster 510 and/or a NAN management interface address.

The information for performing short-range wireless communication via the second communication method may include information for synchronization between electronic devices to be included in the first cluster 510. The information for synchronization between electronic devices to be included in the first cluster 510 may include parameters related to synchronization configured (or determined) by the first electronic device 511. According to an example, the parameters related to synchronization may include a starting time point of a discovery window of the first cluster 510, an interval of the discovery window of the first cluster 510, and/or a duration of the discovery window of the first cluster 510.

The first electronic device 511 may transmit a response message, including a TSF of the first communication method and an offset for determining a starting time point of a discovery window of the first cluster 510, to the second electronic device 521 via the first communication method. The offset may be included in the TSF of the first communication method. The offset may be configured in some of the designated bits (e.g., 64 bits) allocated to the TSF of the first communication method. In an example, the offset may be configured in 23 bits of the 64-bit TSF.

In operation 1040, the first electronic device 511 may be connected to the second electronic device 521 via the second communication method.

The second electronic device 521 may receive information for synchronization of the first cluster 510 before activation of the second communication method and may reduce the latency of data transmission and/or reception via the second communication method. After completing synchronization of the first cluster 510, the second electronic device 521 may transmit data to the first electronic device 511 via the second communication method. Alternatively, the second electronic device 521 may not activate the communication circuit for data transmission and/or reception during the discovery window duration of the first cluster 510 after completing synchronization of the first cluster 510. In this case, the second electronic device 521 may maintain the synchronization state of the first cluster 510 and activate the communication circuit during the discovery window duration of the first cluster 510 when data transmission and/or reception occurs.

The second electronic device 521 according to an embodiment may receive configuration information of a data path of the second communication method before activation of the second communication method and may reduce the latency of data transmission and/or reception via the second communication method. For example, since the configuration information of the data path of the second communication method is received before synchronization with the first cluster 510 is completed, the second electronic device 521 may transmit data to the first electronic device 511 via the second communication method or receive data transmitted by the first electronic device 511 after synchronization with the first cluster 510 is completed. Therefore, the latency of data transmission and/or reception via the second communication method may be reduced.

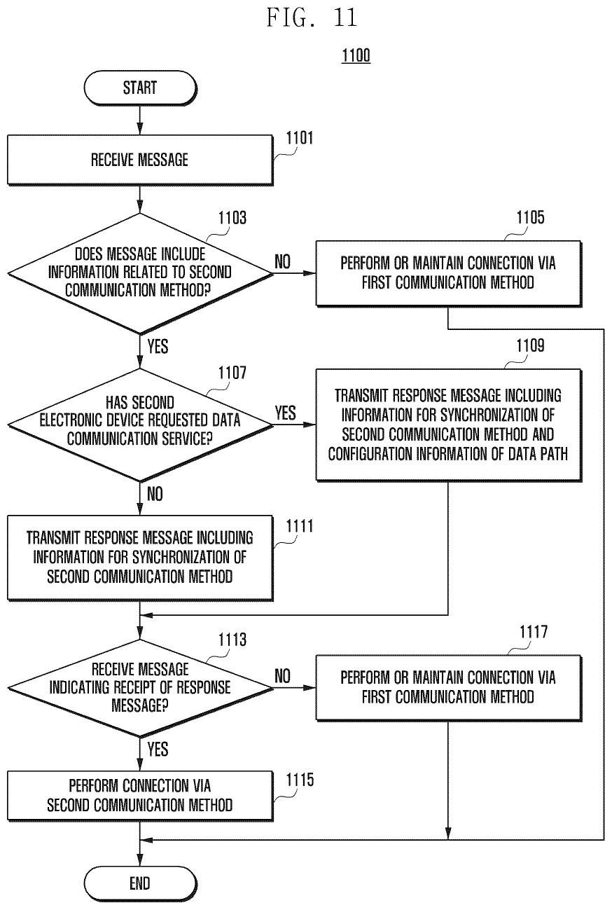

FIG. 11 is an operation flowchart 1100 illustrating an operation method of an electronic device according to an embodiment.

In operation 1101, a first electronic device (e.g., the first electronic device 511 of FIG. 5A) may receive a message from a second electronic device (e.g., the second electronic device 521 of FIG. 5A) via a first communication method.

When the first electronic device 511 is connected to the second electronic device 521 via the first communication method, the first electronic device 511 may receive a message included in various signals (e.g., a beacon signal, a probe request frame, and/or a probe response frame) defined in the first communication method from the second electronic device 521.

When the first electronic device 511 searches for the second electronic device 521 via the first communication method, the first electronic device 511 may receive a message included in a signal (e.g., a probe request frame) defined in the first communication method from the second electronic device 521.

In operation 1103, the first electronic device 511 may identify whether information related to the second communication method is included in the message.

The information related to the second communication method may include an information element (e.g., a NAN information element (IE)) of the second communication method. The information element of the second communication method may include various information on the second communication method. According to an example, the information element of the second communication method may include capability information related to the second communication method and/or information indicating whether the second electronic device 521 supports the second communication method. Alternatively, the information element of the second communication method may include at least one of master indication information, cluster information, service identifier list information, service descriptor information, connection capability information, wireless LAN infrastructure information, peer to peer (P2P) operation information, independent basic service set (IBSS) information, mesh information, further proximity network service discovery information, further availability map information, country code information, ranging information, cluster discovery information, or vendor specific information.

The information related to the second communication method may be included in various signals (e.g., a beacon signal, a probe request frame, and/or a probe response frame) defined in the first communication method.

In operation 1105, the first electronic device 511 may establish a connection or maintain a connection with the second electronic device 521 via the first communication method, based on that information related to the second communication method is not included in the message (operation 1103-N).

The first electronic device 511 may control the communication circuit 610 such that a connection with the second electronic device 521 is established via the first communication method, based on that information related to the second communication method is not included in the discovery message transmitted by the second electronic device 521. Alternatively, the first electronic device 511 may control the communication circuit 610 such that a connection with the second electronic device 521 is established via the first communication method, based on that information indicating that the second electronic device 521 does not support the second communication method or cannot be connected via the second communication method is included in the discovery message transmitted by the second electronic device 521.

In operation 1107, the first electronic device 511 may determine whether the second electronic device 521 has requested a data communication service, based on that information related to the second communication method is included in the message (operation 1103-Y).

According to an example, the first electronic device 511 may control the communication circuit 610 such that a connection with the second electronic device 521 is established via the second communication method, based on that information related to the second communication method is included in the discovery message transmitted by the second electronic device 521. Alternatively, the first electronic device 511 may control the communication circuit 610 to establish a connection with the second electronic device 521 via the second communication method, based on that information indicating that the second electronic device 521 supports the second communication method is included in the discovery message transmitted by the second electronic device 521.

The first electronic device 511 may determine to establish a connection with the second electronic device 521 via the second communication method and activate an interface for performing the second communication method. The interface using the second communication method may include a hardware interface (e.g., the communication circuit 610) and/or a software interface (e.g., an interface for processing data via the second communication method).

The first electronic device 511 may generate (or activate) a cluster of the second communication method (e.g., the first cluster 510 of FIG. 5A) as part of an operation of performing the second communication method. The first electronic device 511 may perform configuration related to a discovery window of the first cluster 510 as part of an operation of performing the second communication method. The configuration related to the discovery window may include a starting time point of the discovery window, an activation duration of the discovery window, and/or a duration of the discovery window.

According to an example, in performing configuration related to the discovery window of the first cluster 510, the first electronic device 511 may refer to a timing synchronization function (TSF), which is a synchronization function defined in the first communication method. The TSF may be an arbitrary value used for synchronization in the first communication method. For example, the first electronic device 511 may transmit a TSF to the second electronic device 521, and the first electronic device 511 and the second electronic device 521 may configure a counter used for synchronization, based on the TSF value. When the first electronic device 511 and the second electronic device 521 configure a counter using the same TSF value, the first electronic device 511 and the second electronic device 521 may activate data transmission and/or reception durations at substantially the same time.

The first electronic device 511 may configure such that the discovery window period and/or duration is identical to the discovery window period and/or duration value defined in the NAN of the IEEE 802.11 WLAN and may configure, as a starting time point of the discovery window, a value obtained by applying an offset to the starting time point of the activation duration for data transmission and/or reception using the first communication method, which is determined by the TSF of the first communication method.

The first electronic device 511 may configure such that the activation duration of the discovery window is identical to the period of the activation duration of data transmission and/or reception using the first communication method, which is determined using the TSF of the first communication method. The processor 620 may configure such that the size of the activation duration of data transmission and/or reception using the first communication method, which is determined using the TSF of the first communication method, is identical to the size of the duration of the discovery window. The processor 620 may configure, as a starting time point of the discovery window, a value obtained by applying an offset to a starting time point of an activation duration of data transmission and/or reception using the first communication method, which is determined using the TSF of the first communication method.

The first electronic device 511 may identify whether the second electronic device 521 has requested the data communication service by identifying whether information indicating a request for a data communication service via the second communication method is included in the message transmitted by the second electronic device 521.

In operation 1109, the first electronic device 511 may transmit, to the second electronic device 521 via the first communication method, a response message including information for synchronization in the second communication method and configuration information of a data path, based on that the second electronic device 521 requests the data communication service (operation 1107-Y).

The first electronic device 511 may transmit, to the second electronic device 521 via the first communication method, a response message including information for synchronization between electronic devices to be included in the first cluster 510 and configuration information of a data path of the second communication method.

In operation 1111, the first electronic device 511 may transmit, to the second electronic device 521 via the first communication method, a response message including information for synchronization in the second communication method, based on that the second electronic device 521 does not request the data communication service (operation 1107-N).

The first electronic device 511 may identify that the message transmitted by the second electronic device 521 does not include information indicating a request for the data communication service via the second communication method, and may transmit, to the second electronic device 521 via the first communication method, a response message including information for synchronization between electronic devices to be included in the first cluster 510.

In operation 1113, the first electronic device 511 may identify whether a message indicating reception of the response message has been received from the second electronic device 521.

In operation 1115, the first electronic device 511 may establish a connection via the second communication method, based on that the message indicating reception of the response message has been received from the second electronic device 521 (operation 1113-Y).

After a response message is transmitted to the second electronic device 521 via the first communication method, the first electronic device 511 may establish a connection with the second electronic device 521 via the second communication method upon receiving a signal (e.g., ACK) indicating that the response message has been received within a designated time.

In operation 1117, the first electronic device 511 may perform or maintain a connection via the first communication method, based on the failure to receive, from the second electronic device 521, the message indicating reception of a response message has failed to receive (operation 1113-N).

After the response message is transmitted to the second electronic device 521 via the first communication method, the first electronic device 511 may establish a connection with the second electronic device 521 via the first communication method rather than the second communication method when the first electronic device 511 fails to receive a signal (e.g., ACK) indicating that the response message has been received within a specified time.

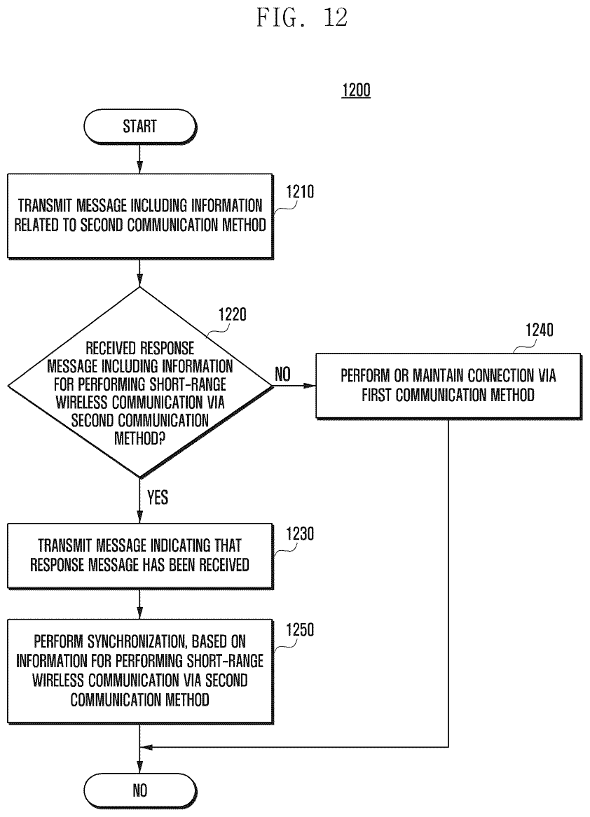

FIG. 12 is an operation flowchart 1200 illustrating an operation method of an electronic device according to an embodiment.

In operation 1210, a second electronic device (e.g., the second electronic device 521 of FIG. 5A) may transmit a message including information related to a second communication method to a first electronic device (e.g., the first electronic device 511 of FIG. 5A) via a first communication method.

The information related to the second communication method may include an information element (e.g., a NAN information element (IE)) of the second communication method. The information element of the second communication method may include various information on the second communication method. According to an example, the information element of the second communication method may include capability information related to the second communication method and/or information indicating whether the second electronic device 521 supports the second communication method. Alternatively, the information element of the second communication method may include at least one of master indication information, cluster information, service identifier list information, service descriptor information, connection capability information, wireless LAN infrastructure information, peer to peer (P2P) operation information, independent basic service set (IBSS) information, mesh information, further proximity network service discovery information, further availability map information, country code information, ranging information, cluster discovery information, or vendor specific information.

The information related to the second communication method may be included in various signals (e.g., a beacon signal, a probe request frame, and/or a probe response frame) defined in the first communication method.

In operation 1220, the second electronic device 521 may determine whether a response message including information for performing short-range wireless communication via the second communication method has been received.

The information for performing short-range wireless communication via the second communication method may include information related to the first cluster 510. According to an example, the information related to the first cluster 510 may include various information including identification information (or identifier) of the first cluster 510 and/or a NAN management interface address.

The information for performing short-range wireless communication via the second communication method may include information for synchronization between electronic devices to be included in the first cluster 510. The information for synchronization between electronic devices to be included in the first cluster 510 may include parameters related to synchronization configured (or determined) by the first electronic device 511. According to an example, the parameters related to synchronization may include a starting time point of a discovery window of the first cluster 510, an interval (or a duration) of the discovery window of the first cluster 510, and/or a duration of the discovery window of the first cluster 510.

The second electronic device 521 may determine whether to perform short-range wireless communication via the second communication method, based on whether information for performing short-range wireless communication via the second communication method is included in the response message to the discovery message.

In operation 1230, upon receiving the response message including information for performing short-range wireless communication via the second communication method (operation 1220-Y), the second electronic device 521 may transmit a message indicating that the response message has been received to the first electronic device 511 via the first communication method.

According to an example, the second electronic device 521 may determine to perform short-range wireless communication via the second communication method, based on that information for performing short-range wireless communication via the second communication method is included in the response message to the discovery message.

Upon receiving a response message including information for performing short-range wireless communication via the second communication method, the second electronic device 521 may control the communication circuit 710 such that a signal indicating that the response message has been received is transmitted to the first electronic device 511.

In operation 1240, the second electronic device 521 may perform or maintain a connection via the first communication method, based on the failure to receive a response message including information for performing short-range wireless communication via the second communication method (operation 1220-N).

According to an example, the second electronic device 521 may determine to perform short-range wireless communication via the first communication method, based on that information for performing short-range wireless communication via the second communication method is not included in the response message to the discovery message.

In operation 1250, the second electronic device 521 may perform synchronization with the first cluster 510, based on the information for performing short-range wireless communication via the second communication method.

Upon determining to perform short-range wireless communication via the second communication method, the second electronic device 521 may perform synchronization with the first cluster 510, based on the TSF of the first communication method and the offset for determining a starting time point of the discovery window of the first cluster 510, both included in the response message.

Therefore, the second electronic device 521 may receive information for synchronization of the first cluster 510 before activation of the second communication method and may reduce the latency of data transmission and/or reception via the second communication method.

Upon determining to perform short-range wireless communication via the second communication method, the second electronic device 521 may configure an NDP, which is a path for exchanging data, based on the configuration information of the data path of the second communication method included in the response message.

The configuration information of the data path of the second communication method may include parameters for configuring a NAN data path (NDP), which is a path for exchanging a service discovery frame (SDF) and/or data which may be exchanged in the discovery duration of the second communication method.

According to an embodiment, the second electronic device 521 may receive configuration information of a data path of the second communication method before activation of the second communication method and may reduce the latency of data transmission and/or reception via the second communication method. For example, since the configuration information of the data path of the second communication method is received before synchronization with the first cluster 510 is completed, the second electronic device 521 may transmit data to the first electronic device 511 via the second communication method or receive data transmitted by the first electronic device 511 after synchronization with the first cluster 510 is completed. Accordingly, the latency of the data transmission and/or reception via the second communication method may be reduced.

An electronic device (e.g., the first electronic device 511 of FIG. 6) according to an embodiment may include a communication circuit (e.g., the communication circuit 610 of FIG. 6). The electronic device 511 may include a processor (e.g., the processor 620 of FIG. 6) operatively connected to the communication circuit 610. The processor 620 may receive a discovery message via a first communication method of short-range wireless communication from an external electronic device (e.g., the second electronic device 521 of FIG. 7). The processor 620 may activate an interface for performing a second communication method, based on identifying that information related to the second communication method of the short-range wireless communication is included in the discovery message. The processor 620 may transmit, to the external electronic device 521 via the first communication method, a response message including the information for performing the short-range wireless communication via the second communication method. The processor 620 may be configured to establish a connection with the external electronic device 521 via the second communication method, based on the information for performing the short-range wireless communication via the second communication method.

In the electronic device 511 according to an embodiment, the processor 620 may be configured to establish, before a connection with the external electronic device 521 via the first communication method, a connection with the external electronic device 521 via the second communication method, based on the information for performing the short-range wireless communication via the second communication method.

In the electronic device 511 according to an embodiment, the processor 620 may be configured to establish, after initiation of the connection via the second communication method, a connection with the external electronic device 521 via the second communication method, based on the information for performing the short-range wireless communication via the second communication method, without service frame exchange of the second communication method and a data path setup procedure of the second communication method.

In the electronic device 511 according to an embodiment, the information related to the second communication method of the short-range wireless communication may include an information element of the second communication method.

In the electronic device 511 according to an embodiment, the information related to the second communication method of the short-range wireless communication may include information indicating that the external electronic device 521 supports the second communication method.

In the electronic device 511 according to an embodiment, the processor 620 may be configured to transmit the response message including the information for performing the short-range wireless communication via the second communication method to the external electronic device 521, based on that the external electronic device 521 requests a data communication service, the response message including information for synchronization between electronic devices included in a cluster of the second communication method, and data path configuration information of the second communication method.

In the electronic device 511 according to an embodiment, the processor 620 may be configured to transmit the response message including the information for performing the short-range wireless communication via the second communication method to the external electronic device 521, based on that the external electronic device 521 does not request a data communication service, the response message including information for synchronization between electronic devices included in a cluster of the second communication method.

In the electronic device 511 according to an embodiment, the processor 620 may be configured to establish a connection with the external electronic device 521 via the first communication method, based on failure to receive, from the external electronic device 521, a signal indicating that the response message has been received.

In the electronic device 511 according to an embodiment, the information for performing the short-range wireless communication via the second communication method may include information for synchronization between electronic devices included in a cluster of the second communication method, and the information for synchronization may be included in information for synchronization of the short-range wireless communication via the first communication method.

An operating method of an electronic device 511 according to an embodiment may include receiving a discovery message via a first communication method of short-range wireless communication from an external electronic device 521. The operating method of the electronic device 511 may include activating an interface for performing a second communication method of the short-range wireless communication, based on identifying that information related to a second communication method of the short-range wireless communication is included in the discovery message. The operating method of the electronic device 511 may include transmitting, to the external electronic device 521 via the first communication method, a response message including information for performing the short-range wireless communication via the second communication method. The operating method of the electronic device 511 may include establishing a connection with the external electronic device 521 via the second communication method, based on the information for performing the short-range wireless communication via the second communication method.

In the operating method of the electronic device 511 according to an embodiment, the establishing of the connection with the external electronic device 521 via the second communication method may include establishing, before a connection with the external electronic device 521 via the first communication method, a connection with the external electronic device 521 via the second communication method, based on the information for performing the short-range wireless communication via the second communication method.

In the operating method of the electronic device 511 according to an embodiment, the establishing of the connection with the external electronic device 521 via the second communication method may include establishing, after initiation of the connection via the second communication method, a connection with the external electronic device 521 via the second communication method, based on the information for performing the short-range wireless communication via the second communication method, without service frame exchange of the second communication method and a data path setup procedure of the second communication.

In the operating method of the electronic device 511 according to an embodiment, the information related to the second communication method of the short-range wireless communication may include an information element of the second communication method.

In the operating method of the electronic device 511 according to an embodiment, the information related to the second communication method of the short-range wireless communication may include information indicating that the external electronic device 521 supports the second communication method.

In the operating method of the electronic device 511 according to an embodiment, the transmitting of the response message may include transmitting the response message including the information for performing the short-range wireless communication via the second communication method to the external electronic device 521, based on that the external electronic device 521 requests a data communication service, the response message including information for synchronization between electronic devices included in a cluster of the second communication method and data path configuration information of the second communication method.

In the operating method of the electronic device 511 according to an embodiment, the transmitting of the response message may include transmitting the response message including the information for performing the short-range wireless communication via the second communication method to the external electronic device 521, based on that the external electronic device 521 does not request a data communication service, the response message including information for synchronization between electronic devices included in a cluster of the second communication method.

In the operating method of the electronic device 511 according to an embodiment, the transmitting of the response message may further include establishing a connection with the external electronic device 521 via the first communication method, based on failure to receive, from the external electronic device 521, a signal indicating that the response message has been received.

In the operating method of the electronic device 511 according to an embodiment, the information for performing the short-range wireless communication via the second communication method may include information for synchronization between electronic devices included in a cluster of the second communication method. The information for synchronization may be included in information for synchronization of short-range wireless communication via the first communication method.

An electronic device 521 according to an embodiment may include a communication circuit 710. The electronic device 521 may include a processor 720 operatively connected to the communication circuit 710. The processor 720 may transmit a discovery message including information related to a second communication method of the short-range wireless communication to an external electronic device 511 via a first communication method of the short-range wireless communication. The processor 720 may receive a response message including information for performing the short-range wireless communication via the second communication method from the external electronic device 511 via the first communication method. The processor 720 may be configured to establish a connection with the external electronic device 511 via the second communication method, based on the information for performing the short-range wireless communication via the second communication method.

In the electronic device 521 according to an embodiment, the processor 720 may be configured to establish, before a connection with the external electronic device 511 via the first communication method, a connection with the external electronic device 511 via the second communication method, based on the information for performing the short-range wireless communication via the second communication method.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a communication circuit; and
a processor operatively connected to the communication circuit; and
memory connected electrically to the processor and configured to store instructions executable by the processor, wherein the instructions, when executed by the processor, cause the electronic device to:
receive a discovery message via a first communication method of short-range wireless communication from an external electronic device;
based on identifying that information related to a second communication method of the short-range wireless communication is included in the discovery message, activate an interface for performing the second communication method;
transmit a response message comprising information for performing the short-range wireless communication using the second communication method to the external electronic device via the first communication method; and
establish a connection with the external electronic device via the second communication method, based on the information for performing the short-range wireless communication using the second communication method.

2. The electronic device of claim 1, wherein the instructions are configured to, when executed by the processor, cause the electronic device to, before establishing a second connection with the external electronic device via the first communication method, establish the connection with the external electronic device via the second communication method, based on the information for performing the short-range wireless communication using the second communication method.

3. The electronic device of claim 1, wherein the instructions are configured to, when executed by the processor, cause the electronic device to, after initiation of establishing the connection via the second communication method, establish the connection with the external electronic device via the second communication method, based on the information for performing the short-range wireless communication using the second communication method, without a service frame exchange procedure of the second communication method and a data path setup procedure of the second communication method.

4. The electronic device of claim 1, wherein the information related to the second communication method of the short-range wireless communication comprises an information element of the second communication method.

5. The electronic device of claim 1, wherein the information related to the second communication method of the short-range wireless communication comprises information indicating that the external electronic device supports the second communication method.

6. The electronic device of claim 1, wherein the instructions are configured to, when executed by the processor, cause the electronic device to, based on that the external electronic device requests a data communication service, transmit the response message comprising the information for performing the short-range wireless communication using the second communication method, the response message comprising information for synchronization between electronic devices included in a cluster of the second communication method and data path configuration information of the second communication method, to the external electronic device.

7. The electronic device of claim 1, wherein the instructions are configured to, when executed by the processor, cause the electronic device to, based on that the external electronic device does not request a data communication service, transmit the response message comprising the information for performing the short-range wireless communication using the second communication method, the response message comprising information for synchronization between electronic devices included in a cluster of the second communication method, to the external electronic device.

8. The electronic device of claim 1, wherein the instructions are configured to, when executed by the processor, cause the electronic device to establish a second connection with the external electronic device via the first communication method, based on a failure to receive, from the external electronic device, a signal indicating that the response message has been received.

9. The electronic device of claim 1, wherein the information for performing the short-range wireless communication via the second communication method comprises information for synchronization between electronic devices included in a cluster of the second communication method, and
wherein the information for synchronization is included in information for synchronization of the short-range wireless communication via the first communication method.

10. An operating method of an electronic device, comprising:
receiving a discovery message via a first communication method of short-range wireless communication from an external electronic device;
based on identifying that information related to a second communication method of the short-range wireless communication is included in the discovery message, activating an interface for performing the second communication method of the short-range wireless communication;
transmitting a response message comprising information for performing the short-range wireless communication using the second communication method to the external electronic device via the first communication method; and
establishing a connection with the external electronic device via the second communication method, based on the information for performing the short-range wireless communication using the second communication method.

11. The operating method of claim 10, wherein the establishing of the connection with the external electronic device via the second communication method comprises, before establishing a second connection with the external electronic device via the first communication method, establishing the connection with the external electronic device via the second communication method, based on the information for performing the short-range wireless communication using the second communication method.

12. The operating method of claim 10, wherein the establishing of the connection with the external electronic device via the second communication method comprises, after initiation of establishing the connection via the second communication method, establishing the connection with the external electronic device via the second communication method, based on the information for performing the short-range wireless communication using the second communication method, without a service frame exchange procedure of the second communication method and a data path setup procedure of the second communication method.

13. The operating method of claim 10, wherein the information related to the second communication method of the short-range wireless communication comprises an information element of the second communication method.

14. The operating method of claim 10, wherein the information related to the second communication method of the short-range wireless communication comprises information indicating that the external electronic device supports the second communication method.

15. The operating method of claim 10, wherein the transmitting of the response message comprises, based on that the external electronic device requests a data communication service, transmitting the response message comprising the information for performing the short-range wireless communication via the second communication method, comprising information for synchronization between electronic devices included in a cluster of the second communication method and data path configuration information of the second communication method, to the external electronic device.

16. The operating method of claim 10, wherein the instructions are configured to, when executed by the processor, cause the electronic device to, based on that the external electronic device requests a data communication service, transmit the response message comprising the information for performing the short-range wireless communication using the second communication method, the response message comprising information for synchronization between electronic devices included in a cluster of the second communication method and data path configuration information of the second communication method, to the external electronic device.

17. The operating method of claim 10, wherein the instructions are configured to, when executed by the processor, cause the electronic device to, based on that the external electronic device does not request a data communication service, transmit the response message comprising the information for performing the short-range wireless communication using the second communication method, the response message comprising information for synchronization between electronic devices included in a cluster of the second communication method, to the external electronic device.

18. The operating method of claim 10, wherein the instructions are configured to, when executed by the processor, cause the electronic device to establish a second connection with the external electronic device via the first communication method, based on a failure to receive, from the external electronic device, a signal indicating that the response message has been received.

19. The operating method of claim 10, wherein the information for performing the short-range wireless communication via the second communication method comprises information for synchronization between electronic devices included in a cluster of the second communication method, and
wherein the information for synchronization is included in information for synchronization of the short-range wireless communication via the first communication method.

20. An electronic device comprising:
a communication circuit;
a processor operatively connected to the communication circuit; and
memory connected electrically to the processor and configured to store instructions executable by the processor, wherein the instructions, when executed by the processor, cause the electronic device to:
transmit a discovery message including information related to a second communication method of short-range wireless communication to an external electronic device via a first communication method of the short-range wireless communication;
receive a response message including information for performing the short-range wireless communication using the second communication method from the external electronic device via the first communication method;
establish a connection with the external electronic device via the second communication method, based on the information for performing the short-range wireless communication using the second communication method.
